(19) United States
(12) Patent Application Publication
(10) Pub. No.: US 2021/0243993 A1
(43) Pub. Date: Aug. 12, 2021

(54) Container

(71) Applicant: Oil-Dri Corporation of America, Chicago, IL (US)

(72) Inventors: Jonathan Coren, Chicago, IL (US); Jessica Moskowitz, Wilmette, IL (US)

(21) Appl. No.: 17/154,642

(22) Filed: Jan. 21, 2021

Related U.S. Application Data
(60) Provisional application No. 62/963,885, filed on Jan. 21, 2020.

(51) Int. Cl. A01K 1/01; B65D 51/24; B65D 21/02; B65D 81/26

(52) U.S. Cl. CPC A01K 1/0107; B65D 81/265; B65D 21/0233; B65D 51/24

(57) ABSTRACT

Aspects of the disclosure related to containers, such as disposable containers. The containers may include a box component and a lid component, where the lid and box may be structured such that the lid will nest within the box in one configuration, and be secured on top of the box and/or coupled onto the top of the box in another configuration. In other embodiments, the lid and box may be structured such that the box will nest within the lid in one configuration, and the lid is secured/coupled on top of the box in another configuration. The box may include sorbing material kept in a cavity, where a cover may enclose the sorbing material.

### CROSS-REFERENCE TO RELATED APPLICATIONS

This application claims the benefit and priority to U.S. Provisional Application Ser. No. 62/963,885, filed Jan. 21, 2020, and is incorporated by reference herein in its entirety.

### TECHNICAL FIELD

Aspects of this disclosure relate generally to containers and disposable containers, more particularly, to containers for holding sorbing material, adsorbent material(s), and/or absorbent material(s), such as clay-based materials, e.g. cat litter.

### BRIEF SUMMARY

Aspects of this disclosure relate generally to containers for holding sorbing material. The containers may be designed with sorbing material being contained within a cavity and covered by a disposable cover. The containers may include a box component and a lid component, where the lid and box may be structured such that the lid will nest within the box in one configuration, and be secured on top of the box in another configuration. In other embodiments, the lid and box may be structured such that the box will nest within the lid in one configuration, and the lid is secured on top of the box in another configuration.

The containers may take embodiments in many different forms. The drawings show example embodiments thereof and the following portion of the disclosure will provide related descriptions. But the present disclosure is to be considered as an exemplification of these concepts and not a limitation to the embodiments illustrated/discussed. In the following description of various example structures, reference is made to accompanying drawings, which form a part hereof, and in which are shown by way of illustration various example devices and/or systems. It is to be understood that other specific arrangements of parts, example devices, systems, and environments may be utilized and structural and functional modifications may be made without departing from the scope of the present disclosure.

### BRIEF DESCRIPTION OF DRAWINGS

The present disclosure is illustrated by way of example and not limited in the accompanying figures in which:

FIG. 1 is a top, front, left perspective view of one embodiment of a container according to aspects of the disclosure;

FIG. 2 is a bottom, front, left perspective view of one embodiment of a container according to aspects of the disclosure;

FIG. 3 is a top, front, left perspective view of one embodiment of a container according to aspects of the disclosure;

FIG. 4 is a top, front, left perspective view of one embodiment of a container according to aspects of the disclosure;

FIG. 5 is a bottom, left perspective view of one embodiment of a container according to aspects of the disclosure;

FIG. 6 is a top, right perspective view of several embodiments of a container according to aspects of the disclosure;

FIG. 7 is a top, front, left perspective view of one embodiment of a container according to aspects of the disclosure;

FIG. 8 is a top, front, left perspective view of one embodiment of a container according to aspects of the disclosure;

FIG. 9 is a top, front, left perspective view of one embodiment of a container according to aspects of the disclosure;

FIG. 10 is a top, front, left perspective view of one embodiment of a container in an example nested configuration, according to aspects of the disclosure;

FIG. 11 is a top, front, left perspective view of one embodiment of a container in an example nested configuration, according to aspects of the disclosure;

FIG. 12 is a bottom, front, left perspective view of one embodiment of a container in an example nested configuration, according to aspects of the disclosure;

FIG. 13 is a top, front, left perspective view of one embodiment of a container in an example coupled configuration, according to aspects of the disclosure;

FIG. 14 is a top, front, left perspective view of one embodiment of a container in an example coupled configuration, according to aspects of the disclosure;

FIG. 15 is left view of one embodiment of a container in an example nested configuration, according to aspects of the disclosure, wherein the right side view is a mirror image thereof;

FIG. 16 is a bottom, front, right perspective view of one embodiment of a container in an example nested configuration, according to aspects of the disclosure;

FIG. 17 is a top, rear, left perspective view of one embodiment of a container lid according to aspects of the disclosure;

FIG. 18 is a top, front, left perspective view of several embodiments of a container in, each in an example nested configuration, according to aspects of the disclosure;

FIG. 19 is a section view of a portion one embodiment of a container in an example nested configuration, according to aspects of the disclosure;

FIG. 20 is a section view of a portion one embodiment of a container in an example coupled configuration, according to aspects of the disclosure;

FIG. 21 is a top, front, left perspective view of one embodiment of a container in an example coupled configuration, according to aspects of the disclosure;

FIG. 22 is a top, front, left perspective view of one embodiment of a container in an example nested configuration, according to aspects of the disclosure;

FIG. 23 is left view of one embodiment of a container in an example nested configuration, according to aspects of the disclosure, wherein the right side view is a mirror image thereof;

FIG. 24 is a top, front, left perspective view of one embodiment of a container in an example nested configuration, according to aspects of the disclosure;

FIG. 25 is a top, front, left perspective view of one embodiment of a container in an example nested configuration, according to aspects of the disclosure;

FIG. 26 is a top, front, left perspective view of one embodiment of a container in an example coupled configuration, according to aspects of the disclosure;

FIG. 27 is a bottom front, left perspective view of one embodiment of a container in an example nested configuration, according to aspects of the disclosure;

FIG. 28 is a bottom front, left perspective view of one embodiment of a container in an example nested configuration, according to aspects of the disclosure;

FIG. 29 is a section view of a portion one embodiment of a container in an example nested configuration, according to aspects of the disclosure;

FIG. 30 is a section view of a portion one embodiment of a container in an example coupled configuration, according to aspects of the disclosure;

FIG. 31 is a top, front, left perspective view of one embodiment of a container in an example nested configuration, according to aspects of the disclosure;

FIG. 32 is a top, front, left perspective view of one embodiment of a container in an example coupled configuration, according to aspects of the disclosure;

FIG. 33 is left view of one embodiment of a container in an example nested configuration, according to aspects of the disclosure, wherein the right side view is a mirror image thereof;

FIG. 34 is a top, left perspective view of several embodiments of a container, each in an example nested configuration, according to aspects of the disclosure;

FIG. 35 is a top, left perspective view of one embodiment of a container in an example nested configuration, according to aspects of the disclosure;

FIG. 36 is a top, left perspective view of one embodiment of a container in an example nested configuration, according to aspects of the disclosure;

FIG. 37 is a top, left perspective view of one embodiment of a container in an example coupled configuration, according to aspects of the disclosure;

FIG. 38 is left view of one embodiment of a container in an example nested configuration, according to aspects of the disclosure, wherein the right side view is a mirror image thereof;

FIG. 39 is a top, front, left perspective view of one embodiment of a container in an example nested configuration, according to aspects of the disclosure;

FIG. 40 is a bottom, front left perspective view of one embodiment of a container in an example nested configuration, according to aspects of the disclosure;

FIG. 41 is a top, front, left perspective view of one embodiment of a container in an example coupled configuration, according to aspects of the disclosure;

FIG. 42 provides an additional view of an example connection feature, according to aspects of the disclosure;

FIGS. 43A and 43B provide additional views of an example connection feature, according to aspects of the disclosure;

FIG. 44 is a top, front, left perspective view of one embodiment of a container according to aspects of the disclosure;

FIG. 45 is a top, front, left perspective view of one embodiment of a container according to aspects of the disclosure;

FIG. 46 is a top, front, left perspective view of one embodiment of a container in an example coupled configuration, according to aspects of the disclosure;

FIG. 47 is a front perspective view of several embodiments of a container, each in an example nested configuration, according to aspects of the disclosure;

FIG. 48 is a front perspective view of several embodiments of a container, each in an example nested configuration, according to aspects of the disclosure;

FIG. 49 is a front perspective view of several embodiments of a container, each in an example nested configuration, according to aspects of the disclosure;

FIG. 50 is a top, left perspective view of one embodiment of a container in an example nested configuration, according to aspects of the disclosure;

Further, it is to be understood that the drawings may represent the scale of different component of one single embodiment; however, the disclosed embodiments are not limited to that particular scale.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope and spirit of the present disclosure.

Aspects of this disclosure relate to containers, including disposable containers, for holding sorbing material, such as a clay-based and/or synthetic material (or a combination thereof), e.g. animal litter (such as, but not limited to, bentonite clay-based materials). The sorbing material may include additional ingredients mixed within, such as deodorizers, fragrances, and/or other additives. The sorbing material may be clumping or non-clumping.

The containers may be used for a variety of purposes, such as during travel or for residential use. The size of the container and/or aspects thereof may vary. For example, for containers used with non-clumping sorbing material, smaller containers may be used, such as containers with a shallower cavity for providing covered sorbing material. For other containers, for example containers used with clumping sorbing material, larger containers may be used, such as containers with a deeper cavity for providing covered sorbing material (which can assist users in scooping/removing the clumping material). In other examples, larger cavities may provide for longer use, even with non-clumping sorbing material provided therein. In some examples, the depth of the sorbing material cavity (which may be all or a portion of the overall container cavity) may be about 1 inch or more, about 1.25 inches or more, about 1.5 inches or more, about 2 inches or more, about 2.5 inches or more, about 3 inches or more, or about 3.5 inches or more.

The container and/or pieces thereof may comprise and/or consist of one or more thermoplastic materials, one or more metals/metallic alloys (including, but not limited to, aluminum-based materials), one or more biodegradable materials, or a combination thereof. In certain embodiments, the container components may be formed of a plastic material. It is to be appreciated that the container components (e.g. box and/or lid and/or other) may be formed of recycled materials in certain embodiments. In certain embodiments, elements or components of the container may be compression molded.

The containers may be designed with sorbing material being contained within a cavity and covered by a disposable cover. The cover may also be configured to provide one or more handle portions extending over part of a sidewall of a container, for example, to provide a convenient place for a user to grab the container, and/or to provide additional structural integrity during transport and/or set-up of the container. As an example, a cover may have a primary wall used to cover the cavity/sorbing material, and then one or more extension walls (which may have a similar dimension or a smaller dimension, such as a dimension about one third of the primary wall dimension, e.g. if the extension wall comes out of the side of the primary wall, and that side of the primary wall provides a width of about 24 inches, the extension wall could have a width of about 8 inches). Any extension wall(s) may have a sufficient length to go to the top edge of any sidewalls of the container (e.g. the box component), and in some embodiments, back down to provide additional reinforcement. In some embodiments, the extension wall(s) of the cover may go over the top of the any sidewalls of the container, back down on the exterior of the container, and wrap around a lip or edge or other surface on the exterior to be held in place. The primary wall and/or the extension wall(s) of the cover may be secured with one or more adhesive materials. When placed in an appropriate location, the cover may be removed to expose the sorbing material provided within the container. In some embodiments, the cover may be formed of a cardboard, plastic and/or aluminum-based material.

The container may include a box component and a lid component, where the lid and box may be structured such that at least a portion of the lid will nest within the box in one configuration, and be secured on top of the box and/or coupled onto the top of the box in another configuration. In other embodiments, the lid and box may be structured such that at least a portion of the box will nest within the lid in one configuration, and the lid is secured/coupled on top of the box in another configuration.

In some examples, the box component includes a bottom wall providing a bottom surface and one or more sidewalls extending generally upward from the bottom, e.g. four sidewalls extending upward to provide a generally rectangular shaped cavity. The bottom wall may include one or more ribs, undulations, and/or curved surfaces, for example to provide traction and/or impart strength to the bottom surface.

The sidewalls may extend upward at a generally perpendicular angle to the bottom, at other angle(s), or both along different portions. The sidewalls of the box component may include one or more rib portions on top of the sidewalls, or spaced away from the sidewalls. For example, a rib portion generally extending back down from the top of the sidewall may be separated from the nearest sidewall by a horizontally extending surface, extending outward from the generally vertical sidewall, for example extending from the top surface of the generally vertical sidewall. In such example, the rib, horizontal sidewall, and vertical sidewall may provide a generally u-shaped configuration at least in part.

In certain embodiments, a generally vertical sidewall has an orientation that is perpendicular or about perpendicular to the bottom wall of the container. In some examples, a generally vertical sidewall has an orientation that is within about 10 degrees of a perpendicular orientation to the bottom wall, within about 15 degrees, within about 20 degrees, within about 25 degrees, within about 30 degrees, or within about 40 degrees. The generally vertical sidewall may be planar, or may have one or more curved portions, or a completed curved vertical surface, where any curved surface(s) may generally follow the angular descriptions noted above (or others). For example, the curved surface may, as a whole, provide about a 30 degree angle (or other angle) between the starting and ending points of the curve. The radius of the curved section may be consistent, or may be larger in some areas and smaller in the others, for example using a smaller radius to provide a relatively more extreme upward path of the sidewall near the bottom surface. In some examples, a sidewall may have about a 45 degree angle to the bottom surface (e.g. within about 5 degrees), or curved surface that provides about a 45 degree angle as determined by the starting and ending points. These descriptions of sidewalls may apply to box and lid sidewalls. In some example, generally similar shapes, angles, and proportions are used such that portions of the lid and box may be consistently adjacent for at least part of the surfaces, to facilitate close nesting of the lid and box.

In some examples, there is a continuous rib portion generally matching the shape provided by the top of the box sidewalls, e.g. providing a generally rectangular shaped rib at the top of the box. There may also be multiple rib portions, such as rib portions corresponding to part or all of the main faces of each sidewall, but not the curved corner transitions joining two sidewalls. In some examples, each of the, e.g., four sides (and/or portions thereof) have a rib portion at the top of the sidewalls.

In some embodiments, a lid component of the box includes one or more sidewalls, e.g. four sidewalls. The lid may be designed to provide two configurations, one where it nests with the box, and one where it is coupled to/secured on top of the box. These configurations may be achieved, in some embodiments, by flipping the lid component upside down. The sidewalls of the lid may provide a generally rectangular shaped cavity, or other shape generally corresponding to the shape of the box. The lid may include textured surfaces and/or indented surfaces to provide text/visual information.

When oriented in the nesting configuration (or oriented as the lid would be when combined with the box in the nesting orientation), each sidewall may extend in a generally vertical manner, and include a generally vertical surface extending upward to provide a generally rectangular shaped cavity. The one or more sidewalls of the lid may include a horizontally extending surface, with a lip connected thereto. The lip may be sized and configured to form a press fit, friction fit, and/or otherwise couple with a corresponding rib structure of the box component. For example, in some embodiments, there is a continuous rib portion of the box generally matching the shape provided by the top of the box sidewalls, e.g. providing a generally rectangular shaped rib, and a corresponding continuous lip structure of the lid generally matching the shape provided by the top (in this orientation) of the lid sidewalls, e.g. providing a generally rectangular shaped lip, that fits around an exterior surface of the rib to couple the rib and lip. There may also be multiple rib portions, such as rib portions corresponding to part or all of the main faces of each sidewall, but not the curved corner transitions joining two sidewalls. The rib and/or lip may include additional materials to help removably couple the components, such as rubber.

The box sidewalls may include one or more transition surfaces. For example, a transition surface may be a generally horizontal surface joining two generally vertical surfaces of the sidewall, such that the horizontal transition surfaces increase the size of the cavity at a particular height. The transition surfaces may also provide an internal ledge surface as part of the sidewall surface, e.g., by providing a horizontal or generally horizontal surface around part or all of the interior cavity at a particular height of the sidewall (where the sidewalls may define a smaller cavity below the transition surface, and a larger cavity above it). The ledge surface may be used, for example, to be adjacent with any disposable cover (which may be optionally joined with one or more adhesive materials) such that any sorbing material placed in the container is at a height within the cavity equal to or below the height of the ledge sidewall surface(s), and the cover is then placed on and/or attached to the ledge. The ledge surface(s) may also be used to facilitate stacking of multiple containers, such that the dimensions of the bottom of the container are smaller than those of the sidewall above the ledge surface, so a bottom of one container will fit on and within the cover/ledge of another container.

In some embodiments, a front sidewall of the box has a protruding section. This section may correspond to a relatively reduced height area of a lid, such that when a lid and box nest the protruding section extends through the open area created by the portion of the lid with a reduced height. Specifically, one or more sidewalls of the lid may have a smaller relative height compared to the other sidewalls, either in part (e.g. half of one sidewall, or about three-quarters of one sidewall) may have a reduced height, or in full. In some examples, all or essentially all of at least one sidewall has a smaller relative height. In some embodiments, the corner transitions between sidewalls may have a reduced height, while in others they will not. In some embodiments, all sidewalls have the same relative height. In some embodiments, the lid has a height equal or nearly equal to the height of the box, while in others the lid has a smaller height, such as a height that is 80% or less, 60% or less or 50% or less of the height of the box. In some embodiments, the lid has a height corresponding to the height of the portion of box sidewalls between the bottom surface and a transition surface. In some embodiments, height of a protruding section of the box has a height similar to or equal to the height of the portion of box sidewalls between the bottom surface and a transition surface, and the lid has a similar corresponding height.

In some examples of embodiments where the lid nets within the box, the box component includes a bottom surface and one or more sidewalls extending generally upward from the bottom, e.g. four sidewalls extending upward to provide a generally rectangular shaped cavity. The sidewalls may extend upward at a perpendicular angle to the bottom, at other angle(s), or both along different portions. The sidewall(s) of the box component may include one or more rib portions and/or indentation portions on top or near the top of the sidewall(s). The sidewall(s) may include a horizontally extending surface, extending outward from top the generally vertical sidewall, above a rib or indentation portion, for example. Some examples include both an indentation and a rib surface. One or more top horizontal surfaces may include a connection structure, such as a recess or cavity designed to interact with a corresponding structure of the lid. In other examples, the horizontal surfaces include a tab, detent, or protrusion structure (such as a mushroom shaped structure) configurated to interact with a corresponding structure (e.g. a recess, cavity, or other structure) on the lid.

In some examples, a lid component of the box includes one or more sidewalls, e.g. four sidewalls. The lid may be designed to provide two configurations, one where it nests within the box, and one where it is coupled to/secured on top of the box. These configurations may be achieved, in some embodiments, by flipping the lid component upside down from one orientation to another. The sidewalls of the lid may provide a generally rectangular shaped cavity. The lid may include textured surfaces and/or indented surfaces to provide text/visual information.

When oriented in the nesting configuration (or oriented as the lid would be when combined with the box in the nesting orientation), each sidewall may extend in a generally vertical manner, and include a generally vertical surface extending upward to provide a generally rectangular shaped cavity. The one or more sidewalls of the lid may include a horizontally extending surface at the top and/or bottom of the sidewall. The sidewalls may include a curved surface configured to fit with any rib and/or indentation of the box sidewalls when in the nested orientation. Any horizontally extending surface designed to be at the bottom of the sidewalls when in the coupled orientation may include one of more connection features, such as tab/detent structures, friction fit protrusions, lips, ribs, circular protrusions etc. designed to interact with a corresponding structural feature of the box. For example, these features may be sized and configured to form a press fit, friction fit, and/or otherwise couple with a corresponding structure of the box component. In any embodiments of this disclosure, any attachment, securement, and/or coupling feature discussed herein may be substituted for another (e.g. an embodiment described with a corresponding rib and lip may instead use snap features or press fitted features that are aligned when the box and lid are oriented in the coupling orientation). Connection features may be used within any embodiment, and any connection features may be positioned such that they couple the box and lid in a nesting orientation, a secured orientation, or both.

For example, in some embodiments, there is a continuous horizontal box surface generally matching the shape provided by the top of the box sidewalls, e.g. providing a generally rectangular shaped horizontal surface on the top of the box, and a corresponding continuous lid structure generally matching the shape provided by the top of the lid sidewalls (in this nested orientation, where when flipped it would be the bottom surface that then couples with the box to have the lid extend upward from the top of the box), e.g. providing a generally rectangular shaped horizontal surface that couples with the top horizontal box surface.

In some embodiments of the container, a box component includes a bottom wall, a first pair of opposed and a second pair of opposed sidewalls extending up from the exterior edges of the bottom wall. The container may include a cover component the includes a cavity surface and at least one handle portions extending upward from the cavity surface. Each sidewall may include a lower sidewall section extending generally upwards from the bottom wall, a transition surface extending away from a top of the lower sidewall section, where the top of the lower sidewall section provides an interior edge of the transition surface, and an upper sidewall section extending generally upwards from an outer edge the transition surface. The bottom wall, lower sidewall sections, and cavity surface may define an interior cavity when the cover is positioned on top of the transition surfaces of the sidewalls. The interior cavity may be at least partially filled with a sorbing material. Each sidewall may include a top horizontal surface extending away from an external surface of the upper sidewall section. The cover may include one or more handles extending generally upwards from the cover surface and then wrapping around to a location underneath and interior to an outer edge of the top horizontal surface. An exterior shape defined by the outer edges of the transition surfaces may be larger than a corresponding shaped exterior shape area defined by the exterior edges of the bottom wall, and an interior shape defined by the interior edges of the transition surfaces may be smaller than the corresponding shaped exterior shape area defined by the exterior edges of the bottom wall. This may allow efficient stacking of multiple containers, e.g. when filled with sorbing material and covered.

In certain examples, a container includes a box component including a bottom wall, a first pair of opposed sidewalls extending up from the bottom wall and a second pair of opposed sidewalls extending up from the bottom wall, where each sidewall includes a first surface and an opposed second surface, and each sidewall further includes one or more transition surfaces joining two primary surfaces of the sidewall and a top horizontal surface extending outward from the top of the first surface of the sidewall.

In some examples, the container includes lid component, including a first pair of opposed lid sidewalls and a second pair of opposed lid sidewalls, where each lid sidewall includes a first surface and an opposed second surface, and each lid sidewall further includes a lid horizontal surface extending outward from a first edge of the first surface of the sidewall.

In some examples, each lid sidewall includes a first lid horizontal surface extending outward from the sidewall a first vertical distance from a second edge of the lid, a vertical sidewall surface joining the first lid horizontal surface and a second lid horizontal surface extending outward from the vertical sidewall, where the second lid horizontal surface is a second vertical distance from the second edge of the lid, and wherein the second vertical distance is less than the first vertical distance.

In some examples, the box and lid are configured such that one of the box and lid will nest inside the other of the box and lid in a first orientation, where the lid horizontal surface is oriented such that the lid sidewalls extend downward from the first edge of the lid, and where the lid is configured to be secured to the top of the box in a second orientation, where the horizontal surface is oriented such that the lid sidewalls extend upward from the first edge of the lid

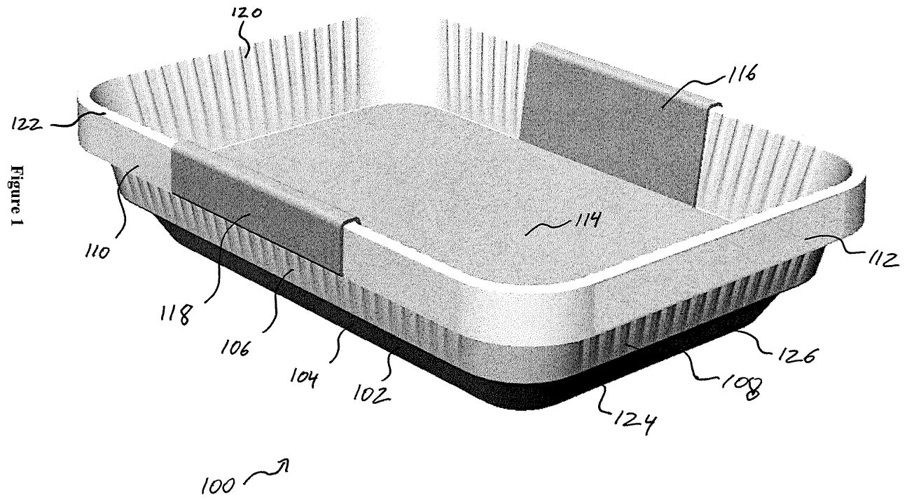

FIGS. 1-6 illustrate example embodiments of a container, according to aspects of the disclosure (although characteristics discussed with regard to this aspect may apply to other aspects, and vice versa, as any characteristics discussed herein with one embodiment may be applied in others). In the example of FIG. 1, container 100 includes a bottom wall (not visible) and a first pair of opposed sidewalls, each with a first external surface and an opposed internal surface, where one wall of the pair 104 is visible. The sidewall 104 includes a lower sidewall section 102 extending generally upwards from the bottom wall, a transition surface extending away from the external surface of the lower section 102 with an upper sidewall section 106 extending generally upwards from the transition surface. In some embodiments, the transition surface is horizontal, while in others it is angled, but has a relative orientation closer to horizontal than vertical (e.g. it may be perpendicular to the sidewall extending generally upward, or at about an 80 degree orientation, or about a 70 degree orientation, or others). The container also provides a second pair of opposed sidewalls, each with a first external surface and an opposed internal surface, where one wall of the pair 126 is visible. The sidewall 126 includes a lower sidewall section 124 extending generally upwards from the bottom wall, a transition surface extending away from the external surface of the lower section 124 with an upper sidewall section 108 extending generally upwards from the transition surface. The sidewalls may include one or more additional transition surfaces and corresponding sidewall sections (e.g. in a generally vertical orientation) before providing a top horizontal surface.

FIG. 1 further shows a cover 114, where the cover, bottom wall, and lower sidewall sections provide an internal cavity. The cavity may contain one or more sorbing materials. The container may have internal upper sidewall surfaces, such as surface 120 of FIG. 1, that transition to a top horizontal surface, such as surface 122 of FIG. 1, which then may transition generally downwards to provide an exterior surface surrounding part or all of the container, such as the surface provided in part by surfaces 110 and 112 of FIG. 1. The cover 114 includes handle portions 118 and 116 provided by extension walls coming out of the primary wall of the cover that encloses the cavity. The handles may wrap around one or more top and/or exterior surfaces of a sidewall, e.g. until terminating at a location underneath and interior to the outer edge of the top horizontal surface.

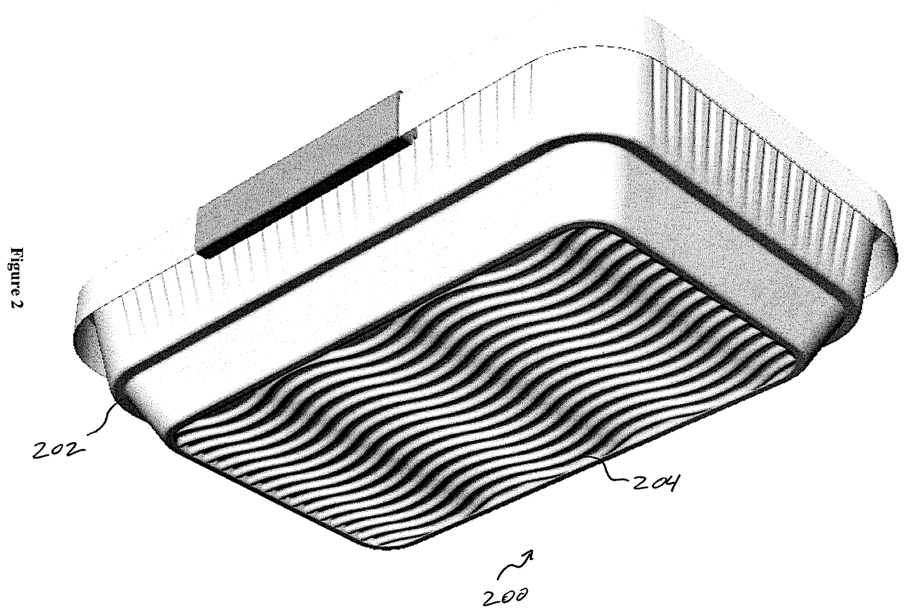

FIG. 2 shows another example of this aspect. FIG. 2 shows container 200 with exterior bottom surface 204, where the exterior of the bottom surface includes non-planar surfaces. A variety of designs may be used to provide visual appeal, impart strength to the surface, and/or to provide traction, such as but not limited to the undulations or rubbing illustrated in FIG. 2. Any non-planar surfaces may also be present on the internal surface of the bottom wall, and the non-planar surfaces may be the same or different. Additional materials such as rubber may be added to provide additional traction. FIG. 2 also shows an example transition surface 202 of the box sidewalls, where the transition surfaces provide a generally horizontal surface between two generally vertical surfaces of each sidewall.

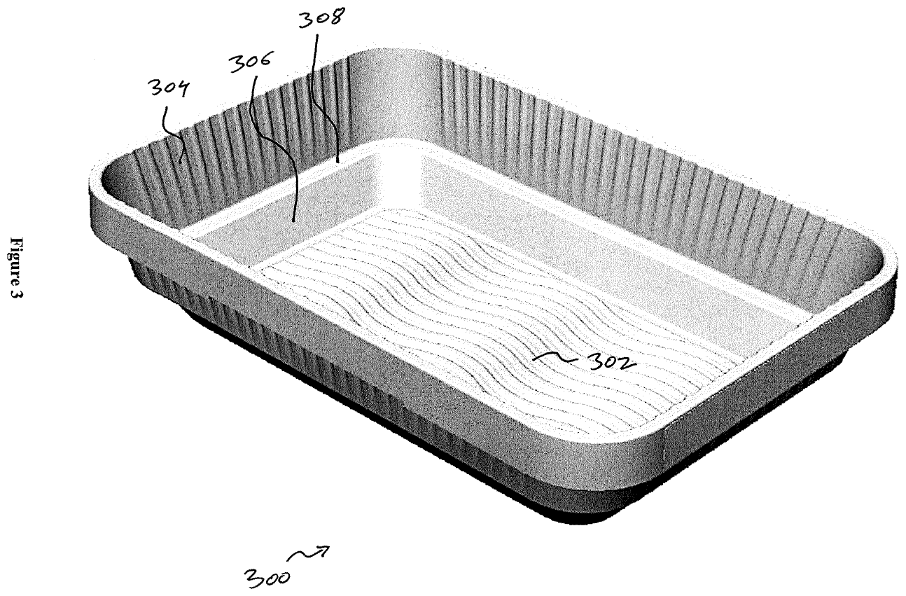

FIG. 3 shows another example of this aspect. FIG. 3 shows container 300 with interior bottom surface 302, where the interior of the bottom surface includes non-planar surfaces. A variety of designs may be used to provide visual appeal, impart strength to the surface, and/or to provide traction, such as but not limited to the undulations or rubbing illustrated in FIG. 2. FIG. 3 also shows an example transition surface 308 of the box sidewalls, where the transition surfaces provide a generally horizontal surface between two generally vertical surfaces of each sidewall, where primary lower sidewall surface 306 and upper sidewall surface 308 are joined by the transition surface. As illustrated here by sidewall section 304, any box and/or lid sidewalls may include ribbing and/or other structural variations to, e.g., impart strength to the box. As illustrated here by sidewall section 306, any box and/or lid sidewalls may be relatively or entirely smooth.

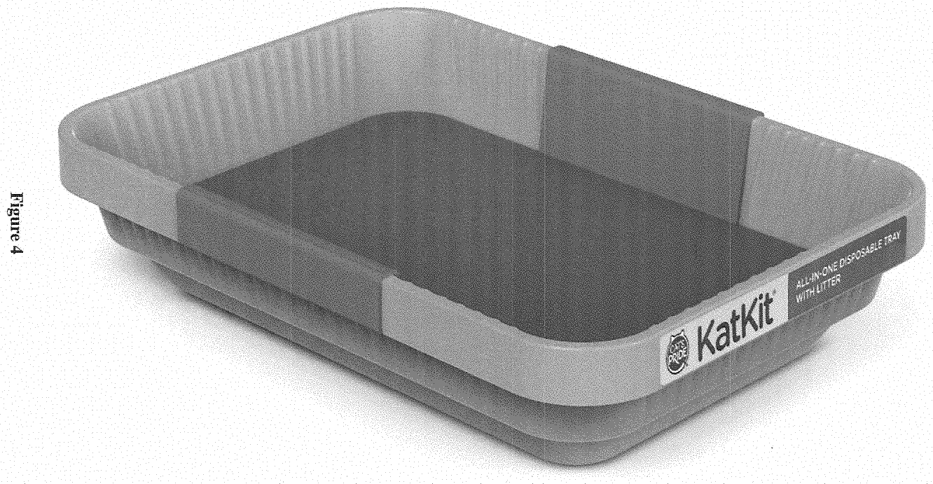

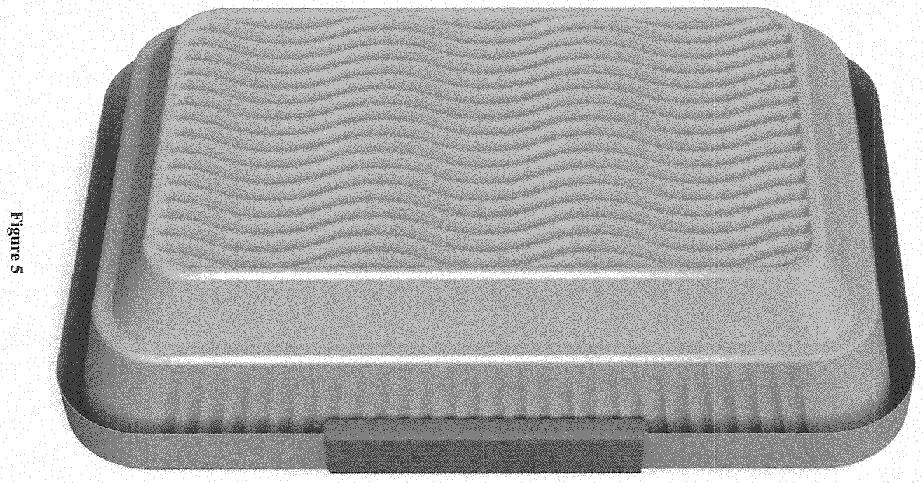

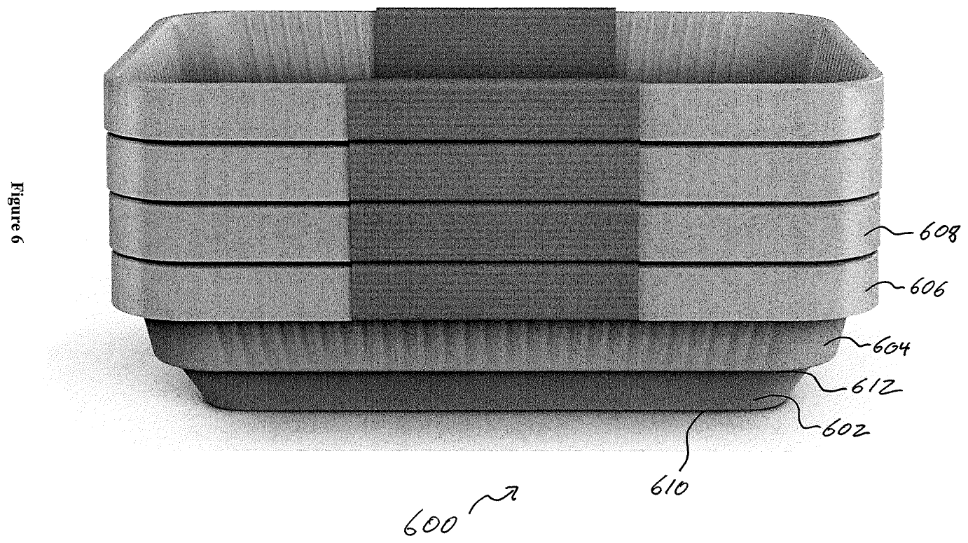

FIGS. 4-6 show other examples of this aspect, including components identical and/or similar to those discussed and/or depicted elsewhere. These Figures illustrate for example, the handles of the cover wrapping around a surface of the box (see FIG. 5), where this may essentially result in a double-beck orientation of the handle. The handles may be secured in place using an adhesive of other measures. Any adhesives or other securing measures used with any portion of the cover are, not so robust that a user cannot remove the cover at a desired time. FIG. 6 illustrates the ability of multiple containers 600 to stack within each other and provide a container system that allows for efficient storage and transport. As illustrated there, certain exterior surfaces of each container come into or near contact with each other (e.g. surfaces 606 and 608 are near each other). In this example, sidewall section 604 provides a cavity, along with an internal ledge surface provided by transition surface 612, to house the bottom of another container, i.e. the bottom portion of another container provided by a bottom wall (like 610) and any adjacent sidewall sections (like 602).

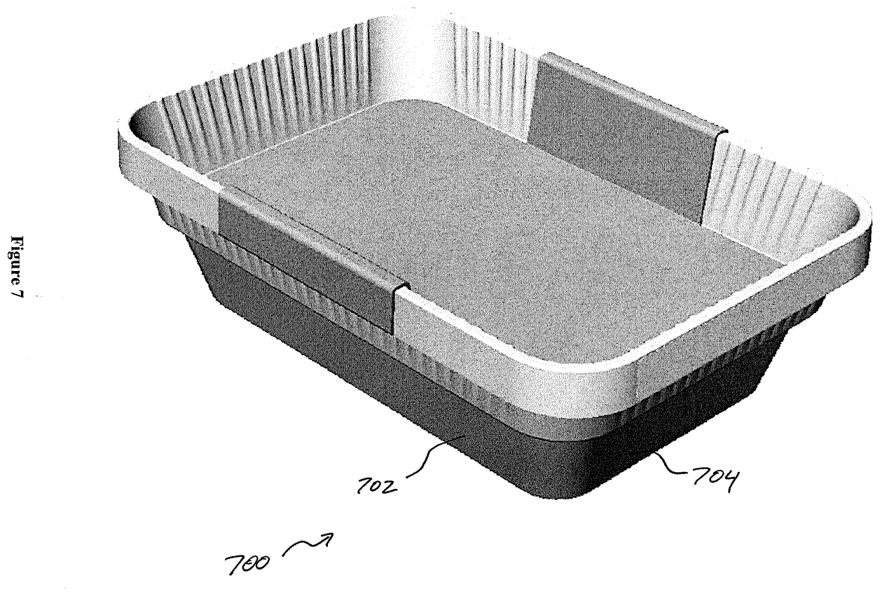

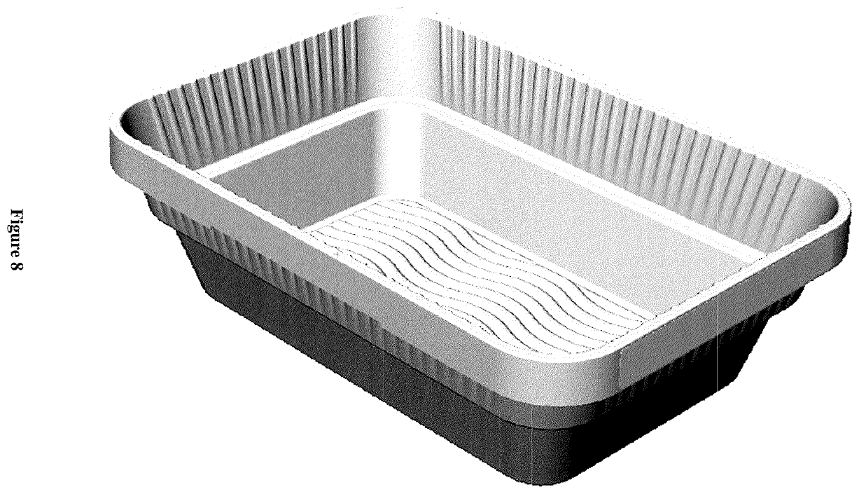

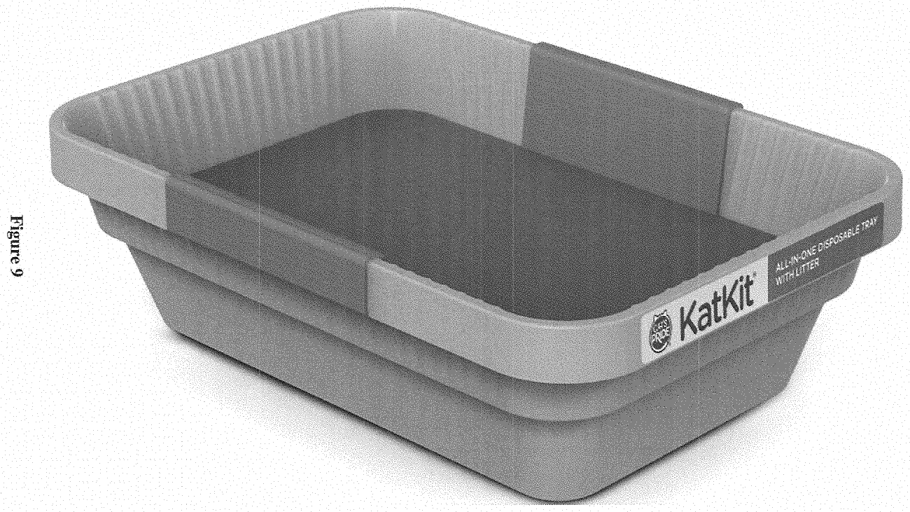

FIG. 7 shows an example container of a related aspect, but one that provides a larger internal cavity, e.g. a larger cavity provided below any ledge surface for holding a sorbing material. In this example, container 700 includes a lower sidewall section 702 (and an opposed, corresponding sidewall section that is not visible) and a lower sidewall section 704 (and an opposed, corresponding sidewall section that is not visible) that define, along with the bottom wall and a cover, an internal cavity. FIG. 8-9 show other examples of this aspect, including components identical and/or similar to those discussed and/or depicted elsewhere.

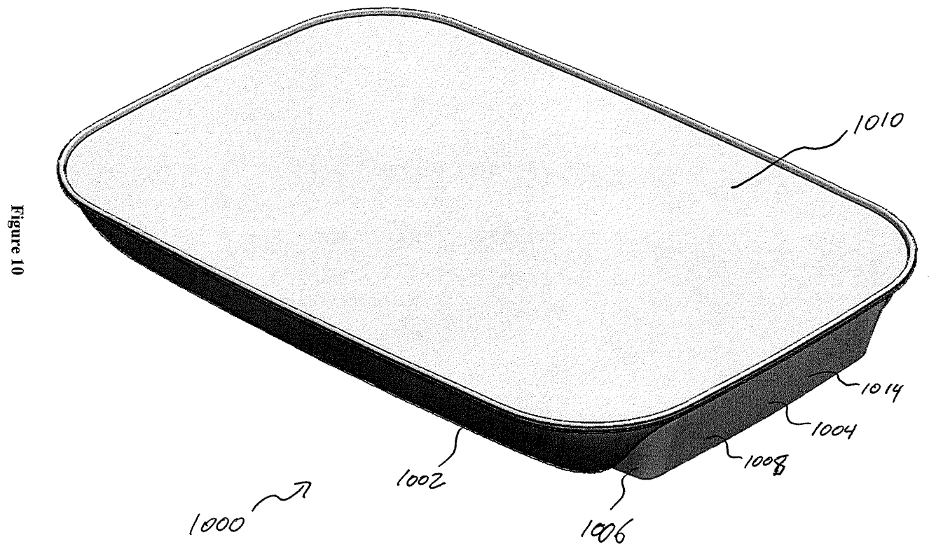

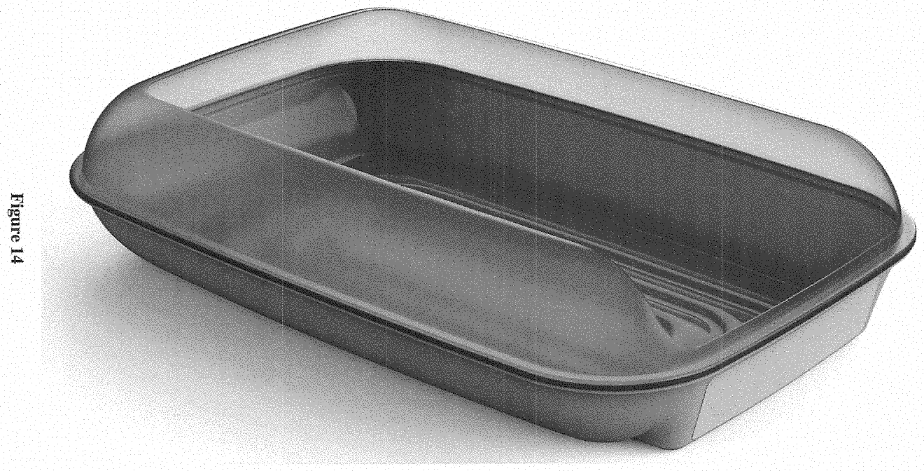

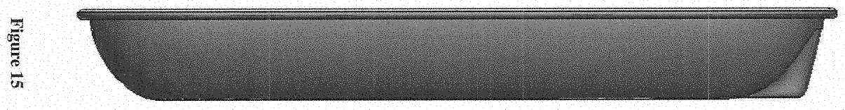

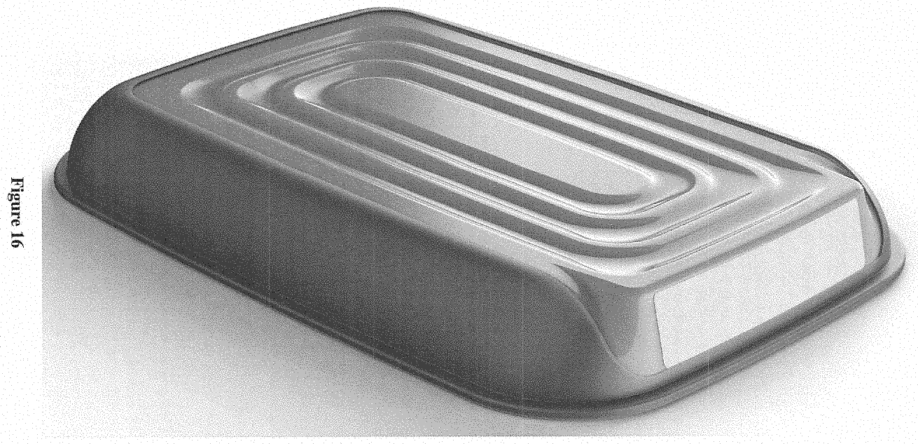

FIGS. 10-20 illustrate example embodiments of a container (or containers), according to aspects of the disclosure (although characteristics discussed with regard to this aspect may apply to other aspects, and vice versa, as any characteristics discussed herein with one embodiment may be applied in others). In the example of FIG. 10, container 1000 includes a box with a bottom wall (not visible) and a first pair of opposed sidewalls, each with a first external surface and an opposed internal surface and a second pair of opposed sidewalls, each with a first external surface and an opposed internal surface. Sidewall 1004 of the box includes a protrusion section 1014 defined by edge surface 1008 and two adjacent connecting surfaces (one, 1006, is visible). The example also includes a cover 1010 and a lid 1002, where the lid includes sidewalls, including sidewall section(s) that have a smaller relative height to allow nesting with the protrusion section. FIG. 10 illustrates an example container in a nested orientation, where the box is nested within the lid, and where the lid and box have similarly shaped sidewall surfaces at least in part to facilitate close and compact nesting.

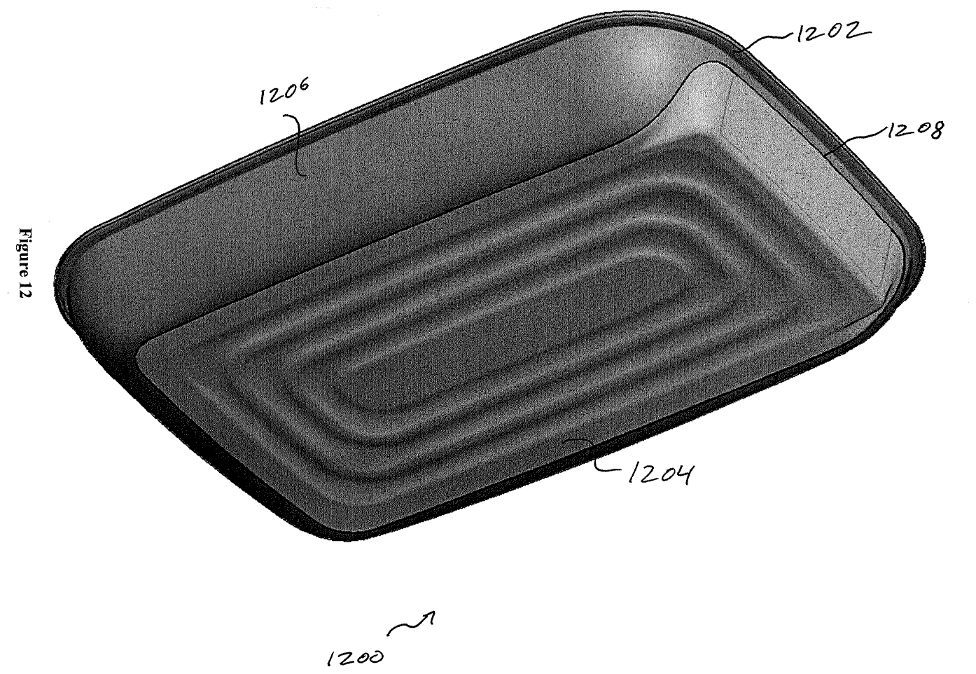

FIG. 12 illustrates an example of this aspect where container 1200 includes a lid component 1210, including a first pair of opposed sidewalls (labeled here with 1206 and the opposed surface) and a second pair of opposed sidewalls (labeled here with 1208 and the opposed surface, where surface 1208 illustrates a reduced height lid sidewall that may assist animal entry into the container when the lid is changed from the shown nested orientation to the secured orientation on top of the box component), each sidewall comprising a first external surface and an opposed internal second surface, each sidewall further comprising a horizontal surface extending outward from the top of the first surface of the sidewall (labelled with 1202 here). This figure also illustrates an external surface of bottom wall 1204 of the box, which illustrates another example of non-planar features, in this case oval and/or rectangular shaped ribs/rings. As shown here, the lid surfaces may have a shape that generally corresponds to any external box surfaces that are adjacent to the lid surfaces when the lid is in the nested configuration, so assist with the fit of the nesting (or, in the case of the protrusion section, the lid surfaces may have a height or other dimension that allow any protrusion to extend beyond the lid when in the nested orientation).

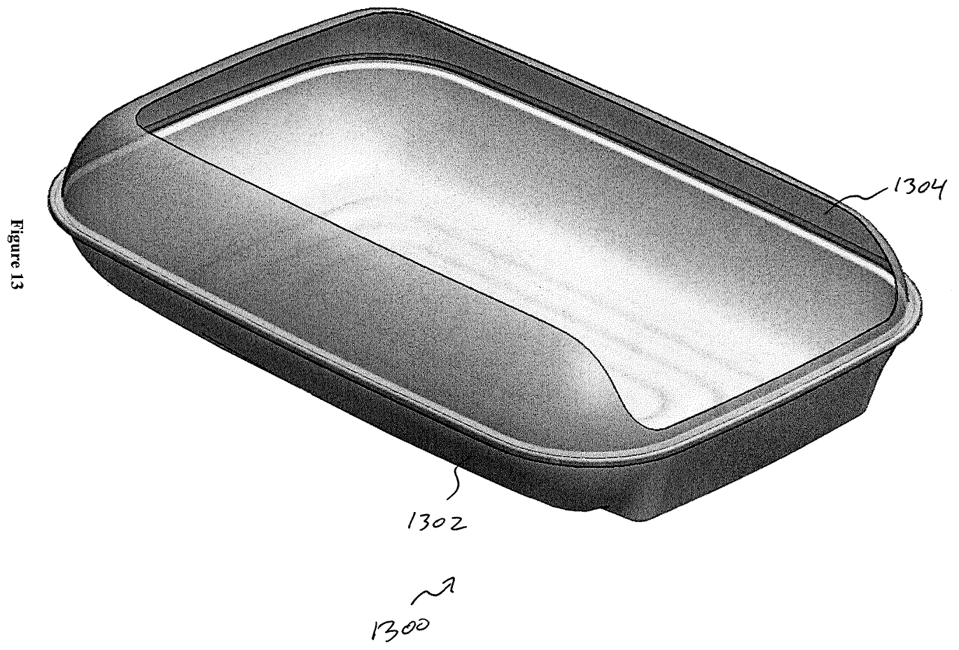

FIG. 13 illustrates an example of this aspect where container 1300 includes a lid component 1304 and a box component 1302, where the lid is in a secured orientation on top of the box component, and where the cover has been removed (to, e.g. expose the internal cavity).

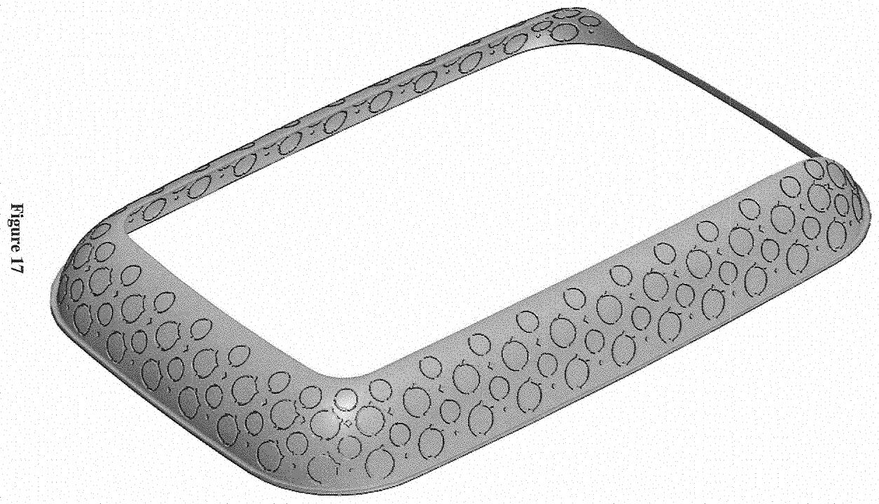

FIG. 17 shows an example of a lid for this aspect that includes indented surfaces to provide text/visual information.

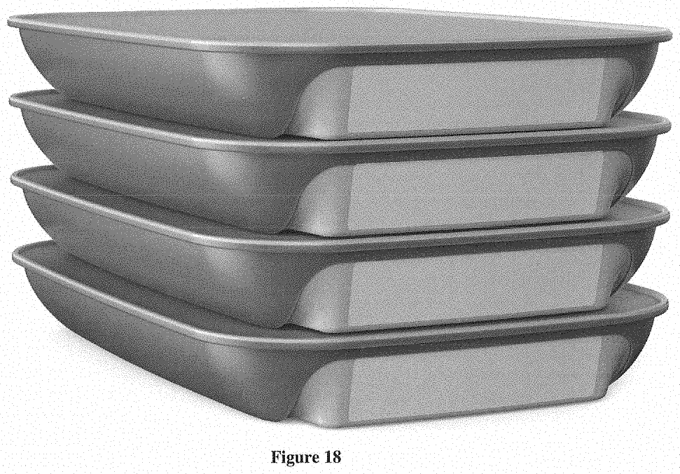

FIG. 18 provides an example of this aspect where a container system of multiple containers allows for stacking of one container on the removeable cover of another container, such that multiple containers with a nested lid and box may be stacked to provide for efficient storage and/or transport.

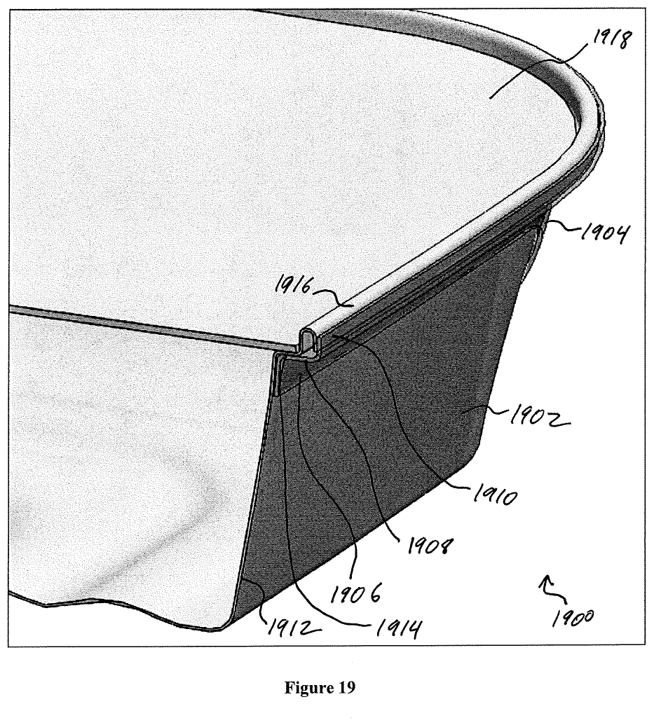

FIG. 19 shows a cross-section of the container 1900's lid and box when in a nested orientation, where the lid material is somewhat transparent. Lid 1904 includes generally vertical sidewall 1906, generally horizontal surface 1908, and lip 1910 on the horizontal surface spaced away from the sidewall surface. Box 1902 includes generally vertical sidewall 1912, generally horizontal surface 1914, and rib 1916 (the rib is generally U-shaped here, but other shapes and dimensions are possible). As illustrated here, the lip and rib may be aligned with each other when the lid and box are in the nested orientation. There may be a friction fit or other securement between the lid and box (e.g. between the lip and rib) in this orientation. A removeable cover 1918 is also visible.

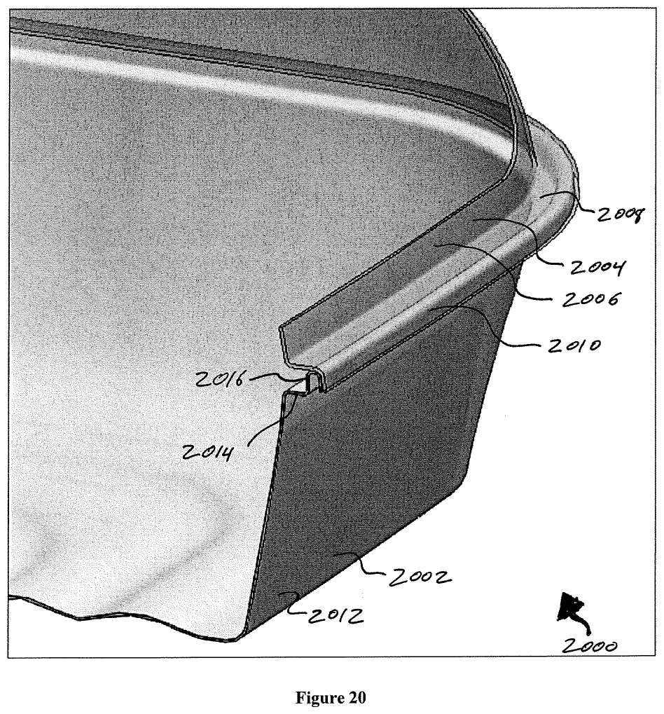

FIG. 20 shows a cross-section of container 2000′s lid and box when in a secured orientation, where the lid material is somewhat transparent. Lid 2004 includes generally vertical sidewall 2006, generally horizontal surface 2008, and lip 2010. Box 2002 includes generally vertical sidewall 2012, generally horizontal surface 2014, and rib 2016 (the rib is generally U-shaped here, but other shapes and dimensions are possible). As illustrated here, the lip and rib may be aligned with each other when the lid and box are in the secured orientation such that the interaction of these components secures the lid on top of the box, so as to provide a larger overall cavity within the container. There may be a friction fit or other securement between the lid and box (e.g. between the lip and rib) in this orientation.

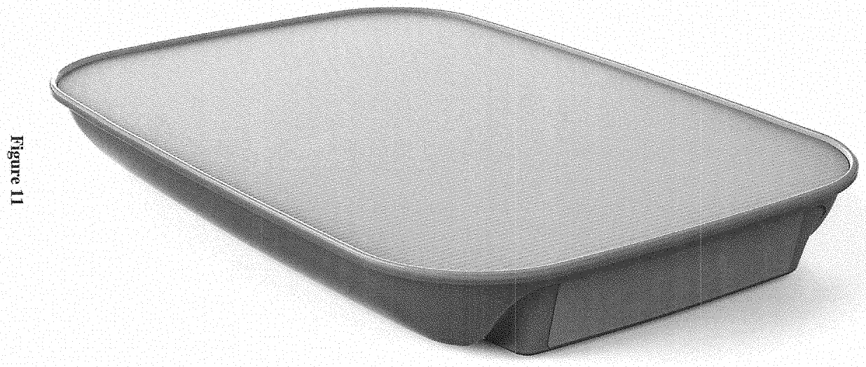

FIGS. 11 and 14-16 show other examples of this aspect, including components identical and/or similar to those discussed and/or depicted elsewhere.

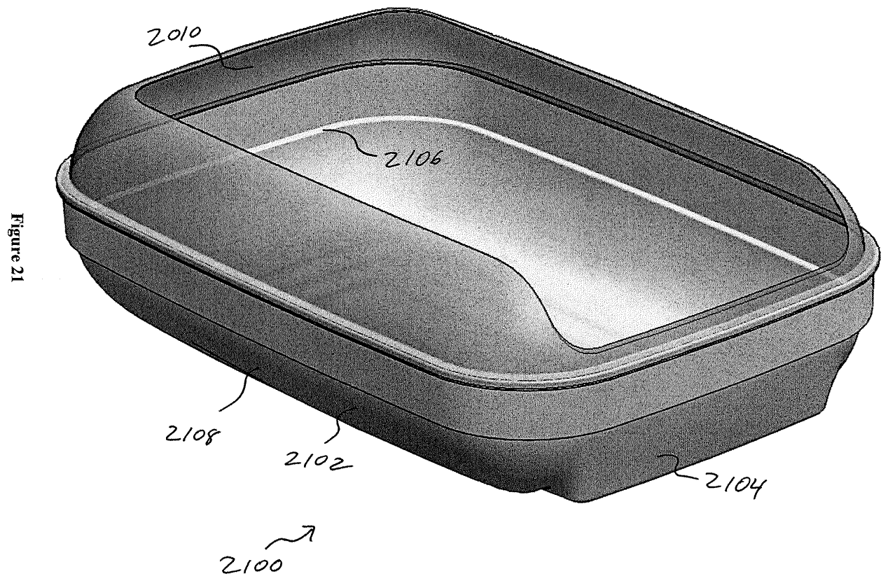

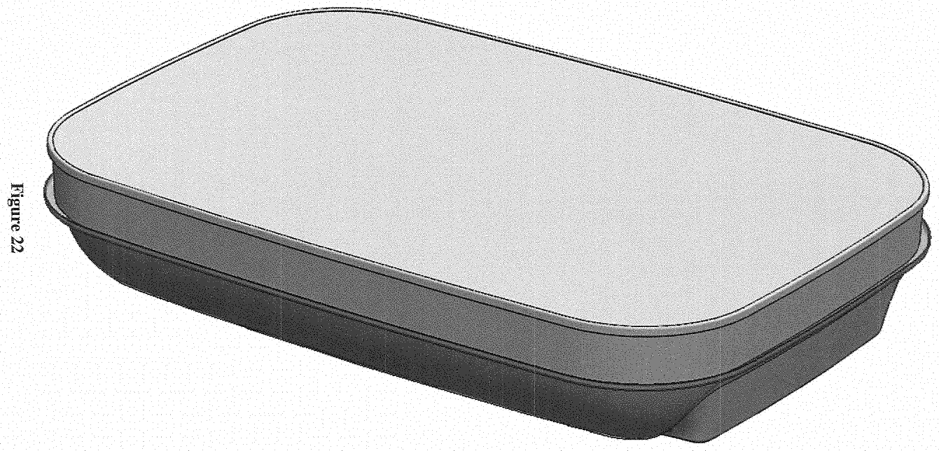

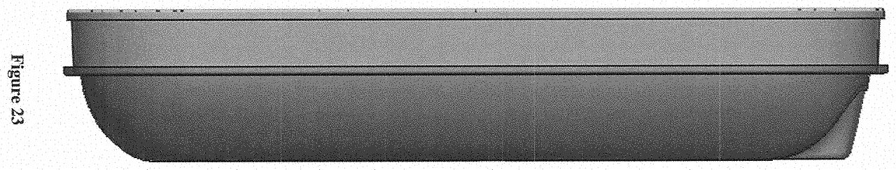

FIG. 21 shows an example container of a related aspect, but one that provides a larger internal cavity, e.g. a larger cavity provided below any ledge surface for holding a sorbing material. In this example, container 2100 includes a box 2108 with lower sidewall section 2102 (and an opposed, corresponding sidewall section that is not visible) and a lower sidewall section 2104 (and an opposed, corresponding sidewall section that is not visible) that define, along with the bottom wall, an internal cavity below ledge surface 2106. Lid 2110 is in a secured orientation, secured on top of the box. FIGS. 22-23 show other examples of this aspect, where these show a nested orientation (and illustrate that the box may have an overall height greater than the lid, and illustrate that the lid may have a height equal to about the height of the lower portion of the internal cavity for holding sorbing material beneath a cover), including components identical and/or similar to those discussed and/or depicted elsewhere.

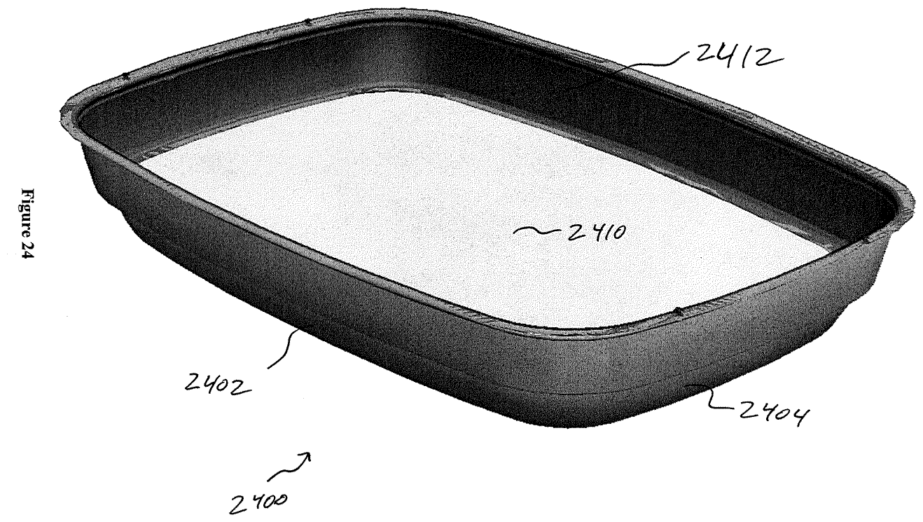

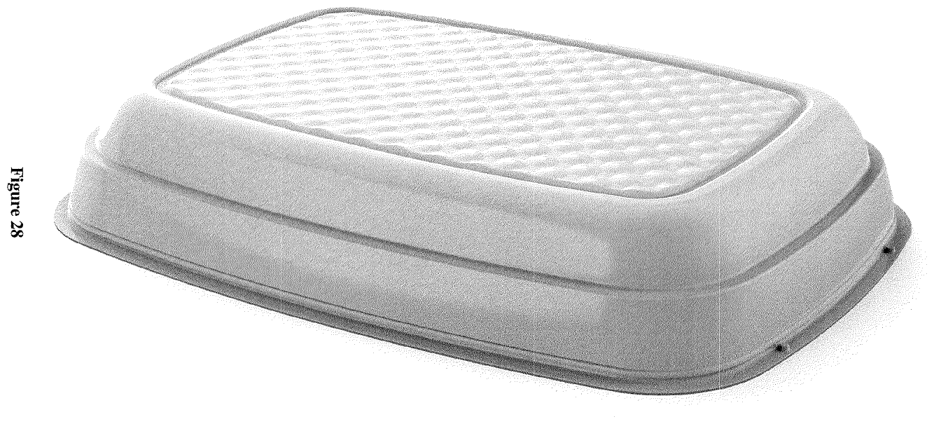

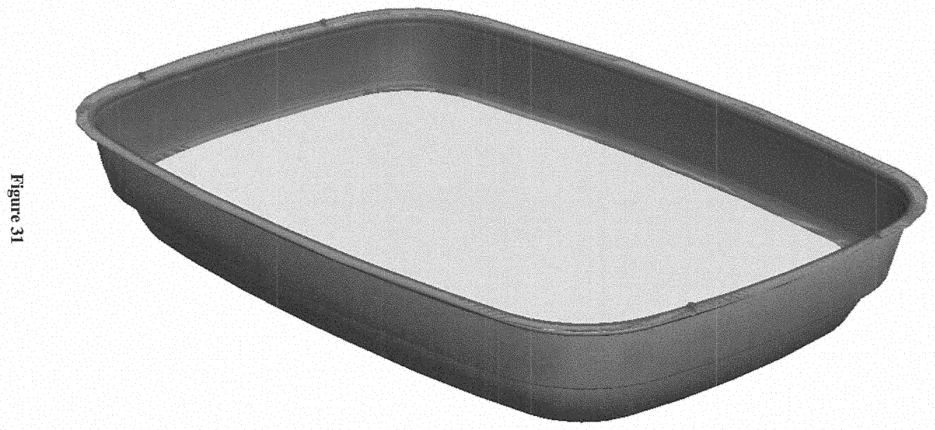

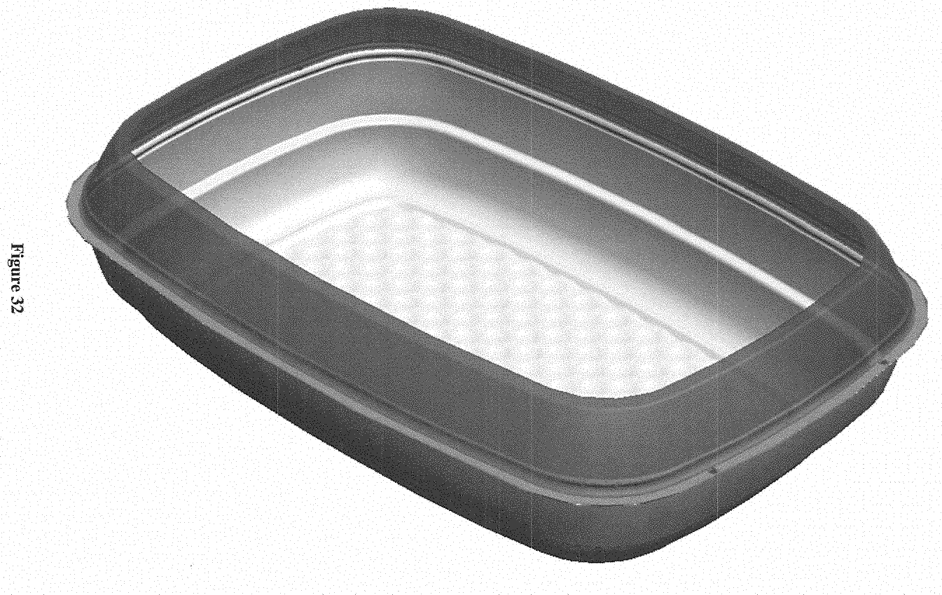

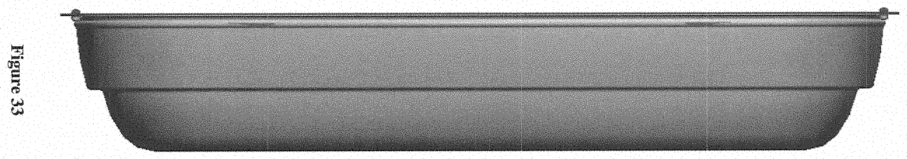

FIGS. 24-38 illustrate example embodiments of a container (or containers), according to aspects of the disclosure (although characteristics discussed with regard to this aspect may apply to other aspects, and vice versa, as any characteristics discussed herein with one embodiment may be applied in others). In the example of FIG. 24, container 2400 includes a bottom wall (not visible) and a first pair of opposed sidewalls, each with a first external surface and an opposed internal surface, where one wall of the pair 2402 is visible, where wall 2402 is extending generally upwards from the bottom wall. The container also provides a second pair of opposed sidewalls, each with a first external surface and an opposed internal surface, where one wall of the pair 2404 is visible, where wall 2404 is extending generally upwards from the bottom wall. The example also includes a cover 2410 and a lid 2412, where the lid includes sidewalls. FIG. 24 illustrates an example container in a nested orientation, where the lid is nested within the box. As shown here, the lid surfaces may have a shape that generally corresponds to any internal box surfaces that are adjacent to the lid surfaces when the lid is in the nested configuration, so assist with the fit of the nesting.

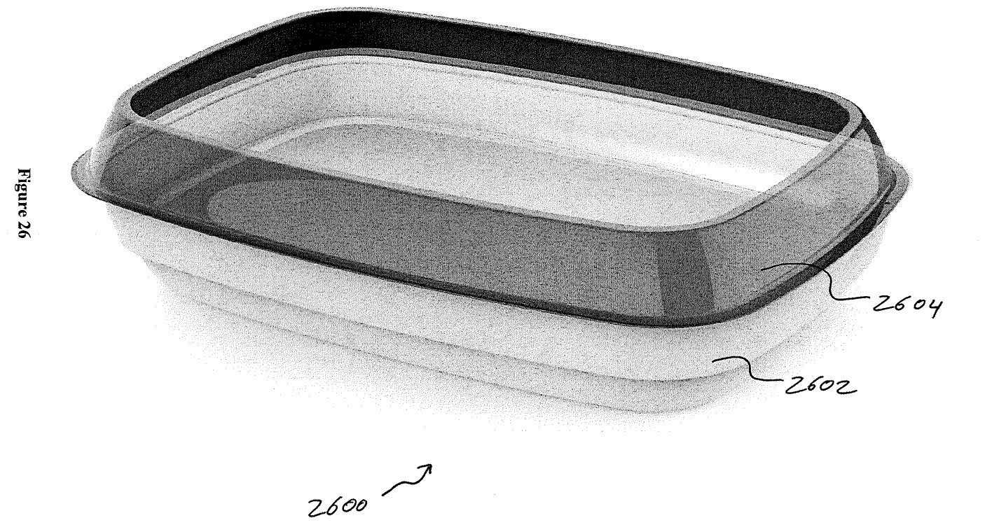

FIG. 26 illustrates an example container in a secured orientation, where the lid is secured on top of the box. FIG. 26 illustrates an example of this aspect where container 2600 includes a lid component 2604 and a box component 2602, where the lid is in a secured orientation on top of the box component, and where the cover has been removed (to, e.g. expose the internal cavity below any lid surface that can include sorbing material).

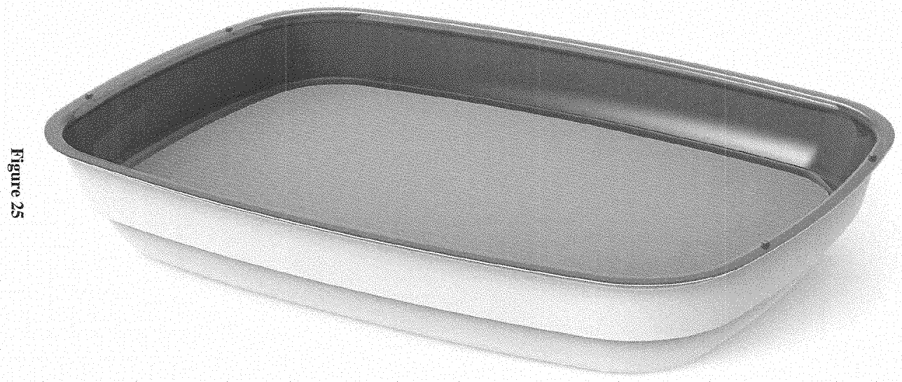

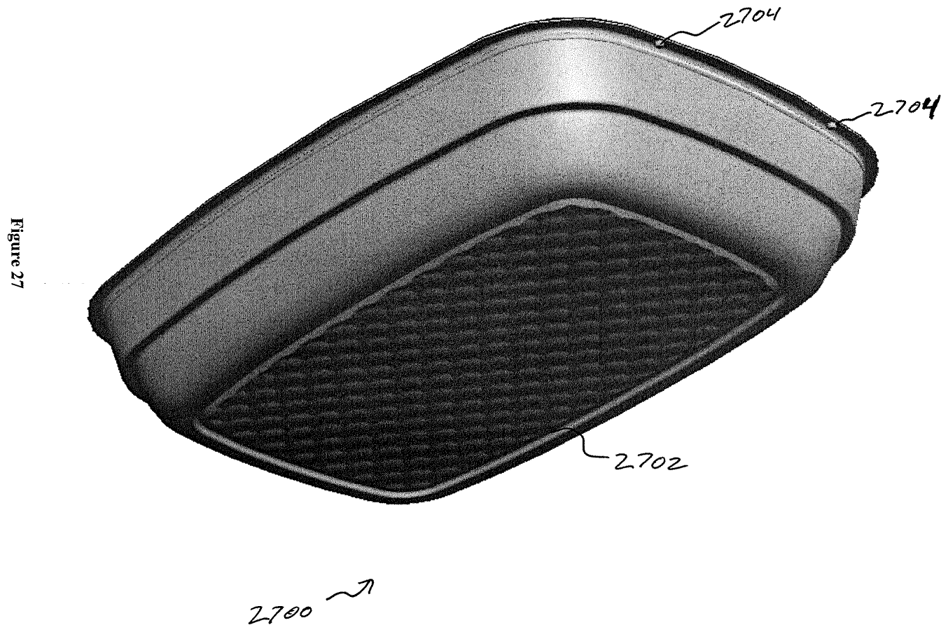

FIG. 27 illustrates an example container of this aspect in a nested orientation where container 2700 includes a box component 2702 and a connection features 2704. The connection features, in this case, are shaped recesses in the box that are sized and positioned to accept a protrusion of the lid (such as the circular protruding surfaces shown in, e.g. FIG. 25 extending up from a horizontal surface of the lid) when the lid is oriented in the secured position. In some examples, one or more connection features of the lid interact with one or more connection features of the box in both the nested and secured orientations. For example, one sidewall may have four connection features, two that interact with connection features of the lid in the nested configuration, and two that interact with connection features on the other side of a lid surface when it is reoriented into a secured orientation.

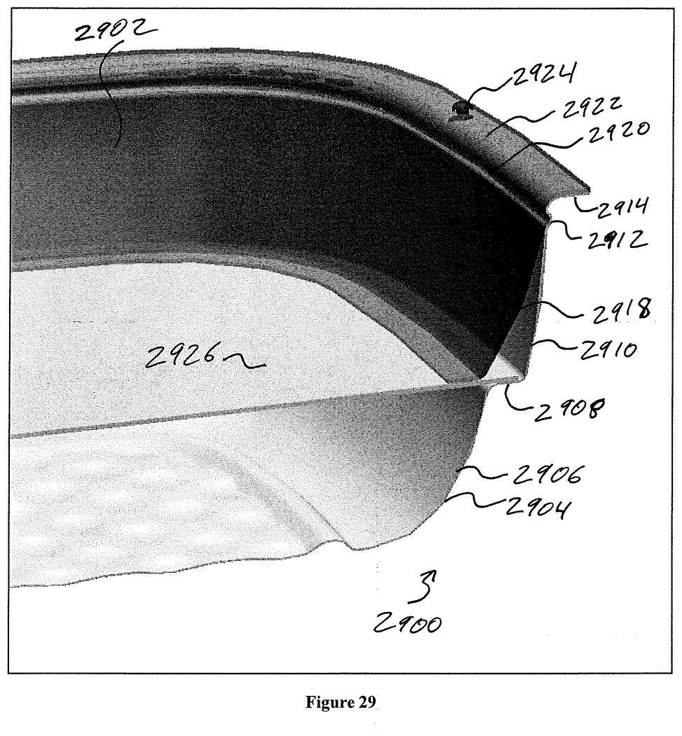

FIG. 29 shows a cross-section of the container 2900′s lid and box when in a nested orientation, where the lid material is somewhat transparent. Box 2904 includes a sidewall section 2906, generally horizontal transition surface 2908, generally vertical sidewall surface 2910, a rib 2912 at the top of the sidewall surface and a horizontal surface 2914 extending away from the generally vertical sidewall surface 2910 (where, in this example, there is a curved transition between the rib and horizontal surface). Lid 2902 includes generally horizontal surface 2916, a generally vertical surface 2918, a corresponding shaped-rib portion 2920 (correspondingly shaped relative to the rib of the box and the indented surface provided therein, which can assist in nesting and securing the lid and box in the nested position) generally horizontal surface 2922 extending out away from the top of the first surface of the sidewall, and connection feature 2924 (which is shown in a “mushroom-shaped” protrusion extending up from the horizontal surface in this orientation, and that can interact with a correspondingly shaped hole or cavity, but may take other forms). A flat, planar cover 2926 is below and adjacent to horizontal surface 2916.

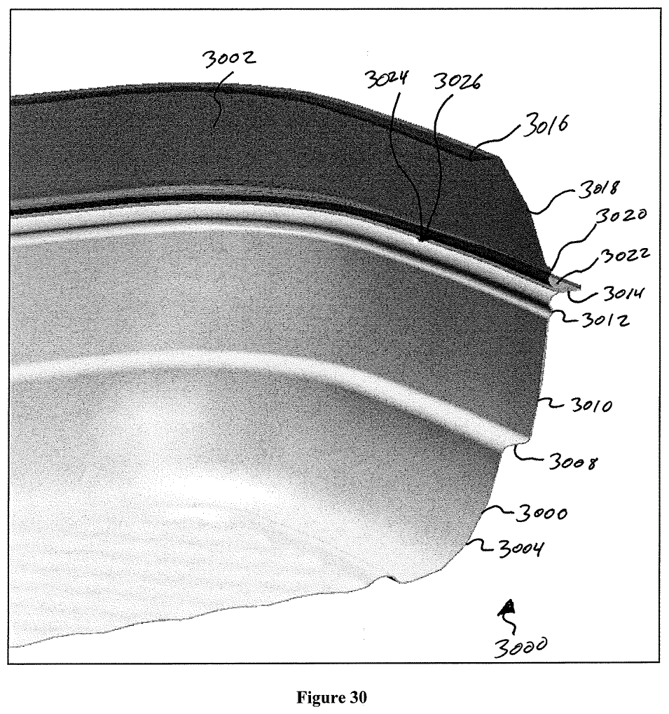

FIG. 30 shows a cross-section of the container 3000′s lid and box when in a secured orientation, where the lid material is somewhat transparent. Box 3004 includes a sidewall section 3006, generally horizontal transition surface 3008, generally vertical sidewall surface 3010, a rib 3012 at the top of the sidewall surface and a horizontal surface 3014 extending away from the generally vertical sidewall surface 3010 (where, in this example, there is a curved transition between the rib and horizontal surface). Lid 3002 includes generally horizontal surface 3016, a generally vertical surface 3018, a corresponding shaped-rib portion 3020 (correspondingly shaped relative to the rib of the box and the indented surface provided therein) generally horizontal surface 3022 extending out away from the first surface of the sidewall (and now, as reoriented, at the bottom of the sidewall), and connection feature 3024 (which is shown in a “mushroom-shaped” protrusion extending up from the horizontal surface in this orientation, and that can interact with a correspondingly shaped hole or cavity, but may take other forms) that has extended through cavity 3026 of the box to secure the box and lid together.

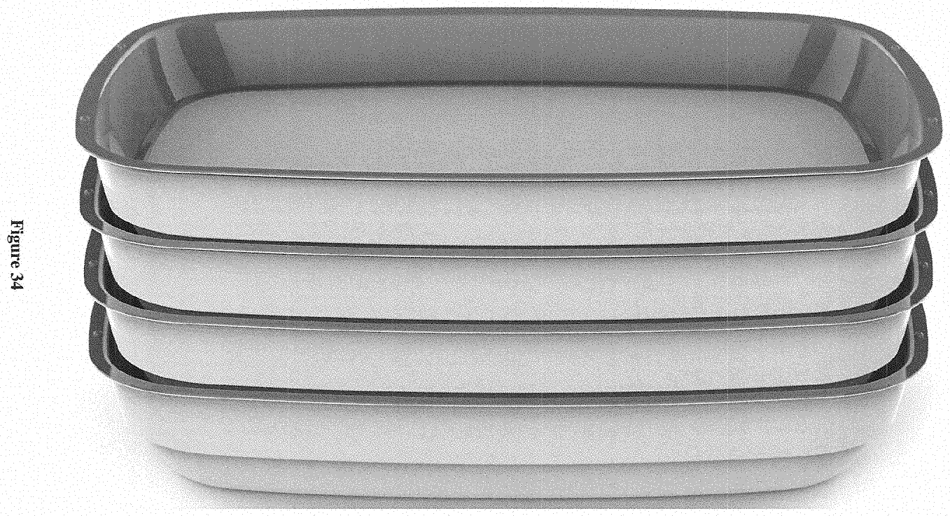

FIG. 34 provides an example of this aspect where a container system of multiple containers allows for stacking of one container on the removeable cover of another container, such that multiple containers with a nested lid and box may be stacked to provide for efficient storage and/or transport.

FIGS. 25, 28 and 31-33 show other examples of this aspect, including components identical and/or similar to those discussed and/or depicted elsewhere.

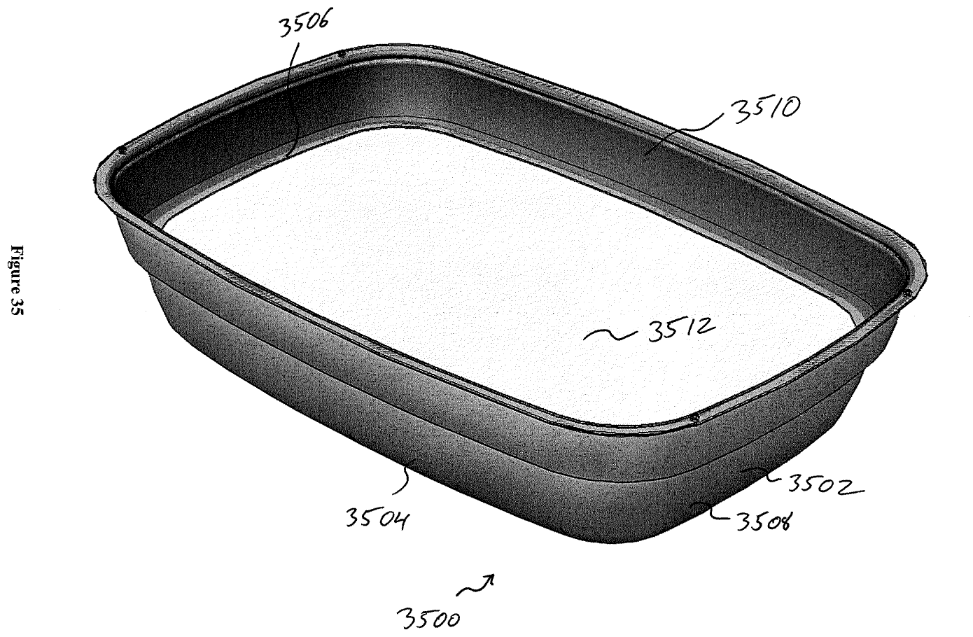

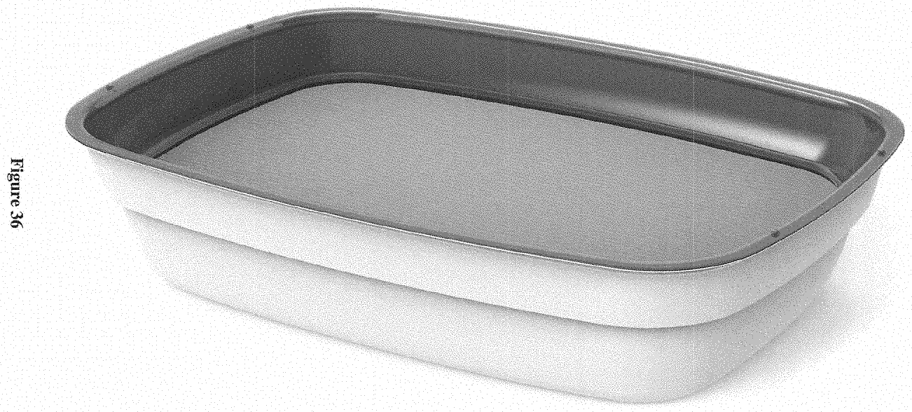

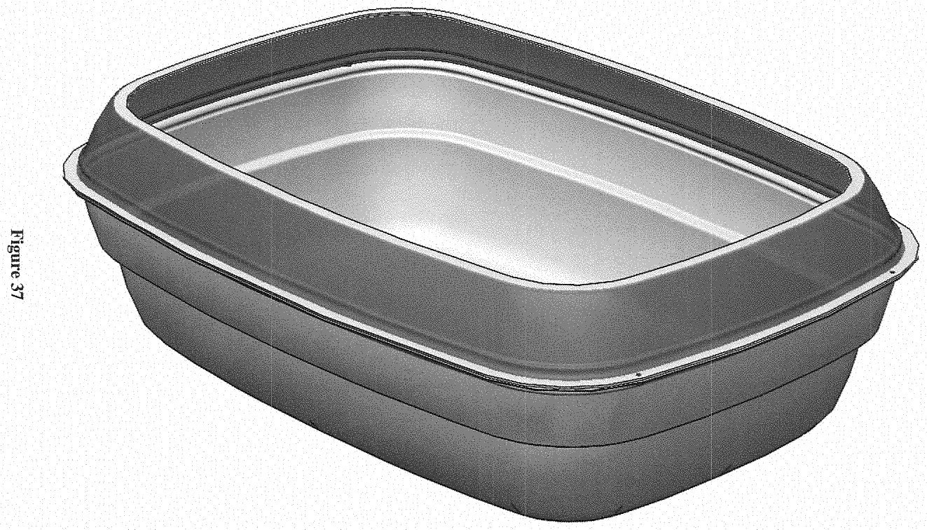

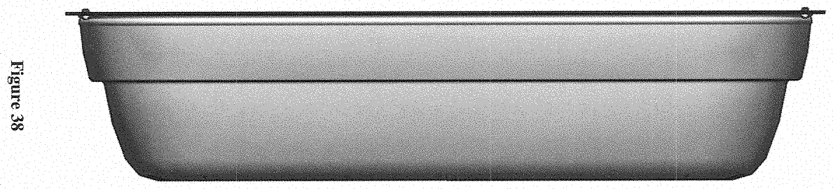

FIG. 35 shows an example container of a related aspect, but one that provides a larger internal cavity, e.g. a larger cavity provided below any ledge surface for holding a sorbing material. In this example, container 3500 includes a box 3508 with lower sidewall section 3502 (and an opposed, corresponding sidewall section that is not visible) and a lower sidewall section 3504 (and an opposed, corresponding sidewall section that is not visible) that define, along with the bottom wall, an internal cavity below ledge surface 3506. Cover 2512 is also visible. Lid 3510 is in a nested orientation, and illustrates that the height of the lid may corresponding to about the height of the sidewalls of the box about the ledge surface. FIGS. 36-38 show other examples of this aspect, where these show a nested orientation (FIGS. 36 and 38) and a secured orientation (FIG. 37), including components identical and/or similar to those discussed and/or depicted elsewhere.

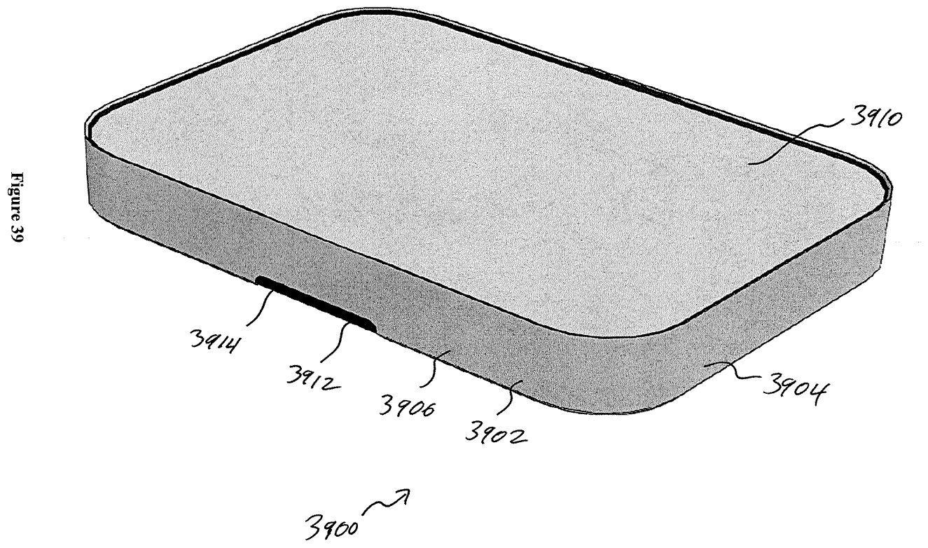

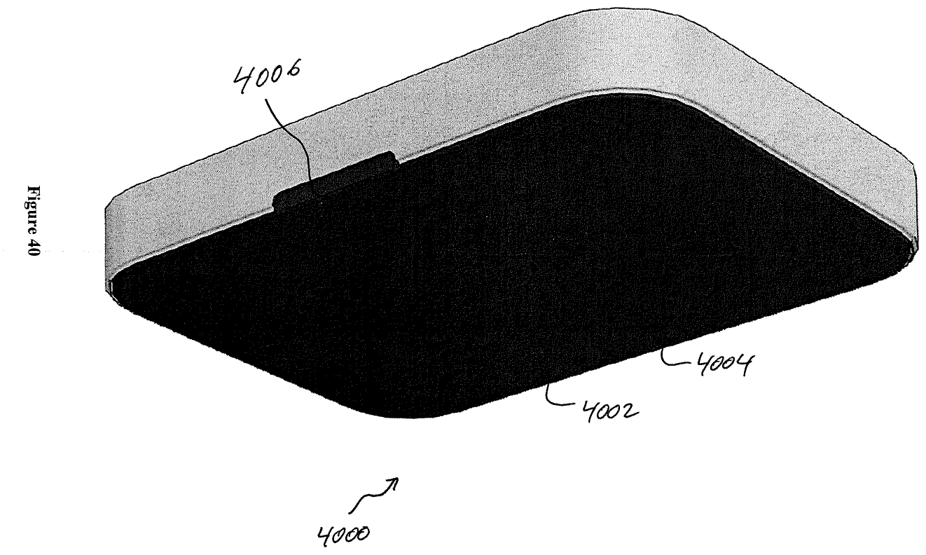

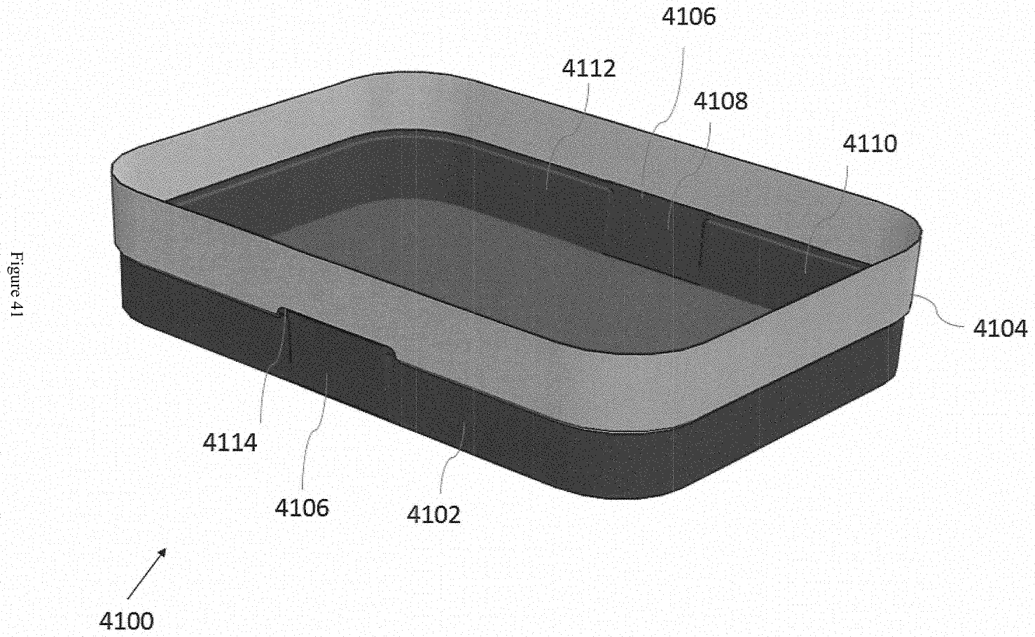

FIGS. 39-41 illustrate example embodiments of a container, according to aspects of the disclosure (although characteristics discussed with regard to this aspect may apply to other aspects, and vice versa, as any characteristics discussed herein with one embodiment may be applied in others). In the example of FIG. 39, container 3900 includes a lid 3906 with a first pair of opposed sidewalls, each with a first external surface and an opposed internal surface, where one wall of the pair 3902 is visible. The lid also provides a second pair of opposed sidewalls, each with a first external surface and an opposed internal surface, where one wall of the pair 3904 is visible. The example also includes a cover 3910 and a box 3912 contained under the cover and within the lid in a nested orientation, where the lid has a roughly oval or rectangular shape that wraps around the sidewalls of the box, but does not include any top of bottom surfaces. The lid includes a connection feature 3914 configured to secure the lid and box together when placed in a secured orientation. FIG. 40 shows an example of this aspect, where the container 4000 has box 4002 with a bottom surface 4004 and box connection features 4006. FIG. 41 shows an example container 4100 with the box and lid in a secured orientation. Box 4102 has lid 4104 removed from the nested orientation with the box and secured via box connection features 4106. In this example, box connection feature is formed from an angled surface 4108 that deviates from the adjacent box sidewall surfaces 4110 and 4112, such that the top of the angled surface may form a friction fit or otherwise couple with a portion of the lid 4114.

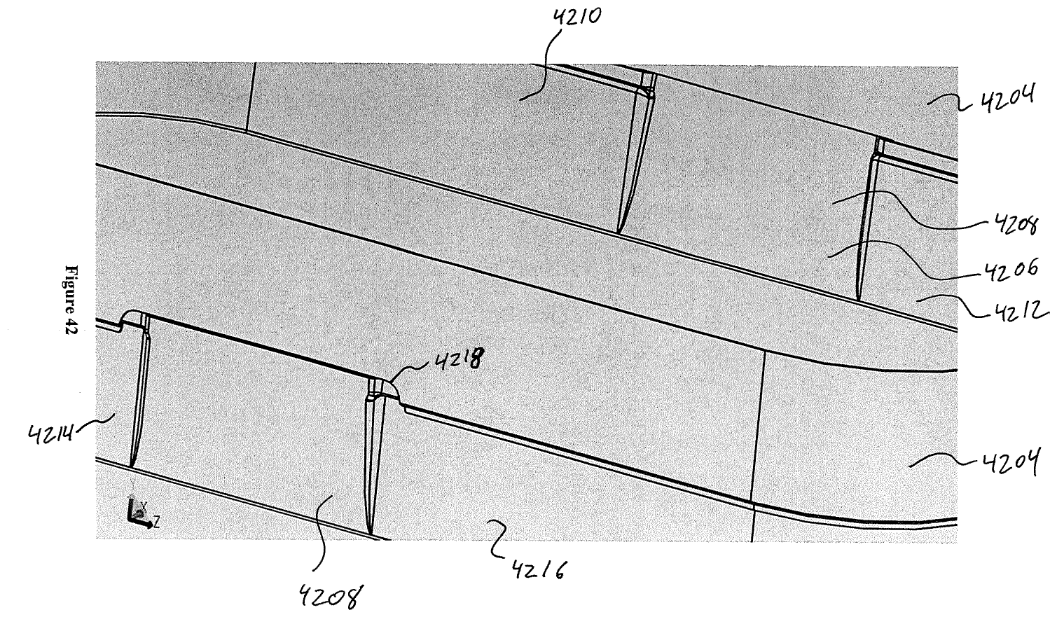

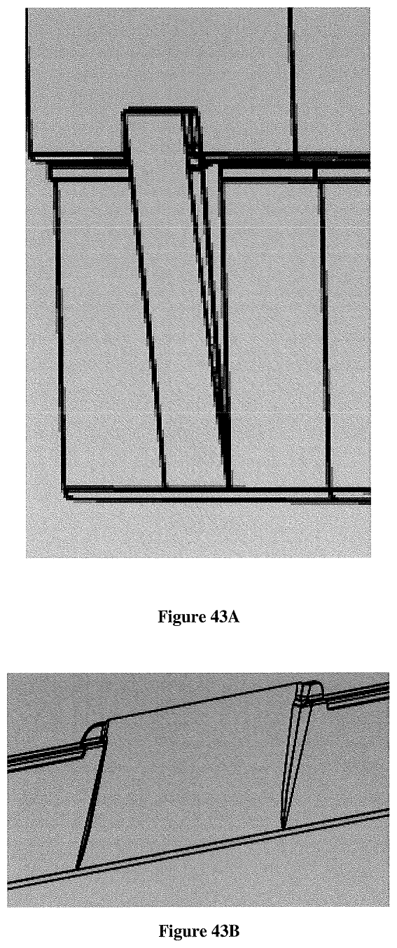

FIG. 42 shows a closer view of the example container similar to that of FIG. 41. Box 4202 has lid 4204 removed from the nested orientation with the box and secured via box connection feature 4206. In this example, box connection feature is formed from an angled surface 4208 that deviates from the adjacent internal box sidewall surfaces 4210 and 4212 and adjacent external sidewall surfaces 4214 and 4216, such that the top of the angled surface may form a friction fit or otherwise couple with the correspondingly shaped indented portion of the lid 4214, e.g. the top of the angled surface may extend past the lid through the indented portion 4218 and press onto the lid. FIGS. 43A and 43B provide additional illustration of embodiments of this concept. As shown in FIG. 43A, a surface of the box may extend past the bottom edge of the lid to couple or assist in the coupling of the lid and box.

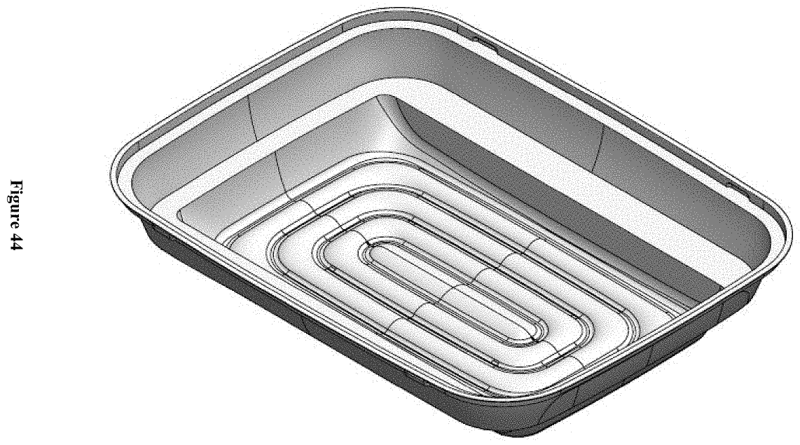

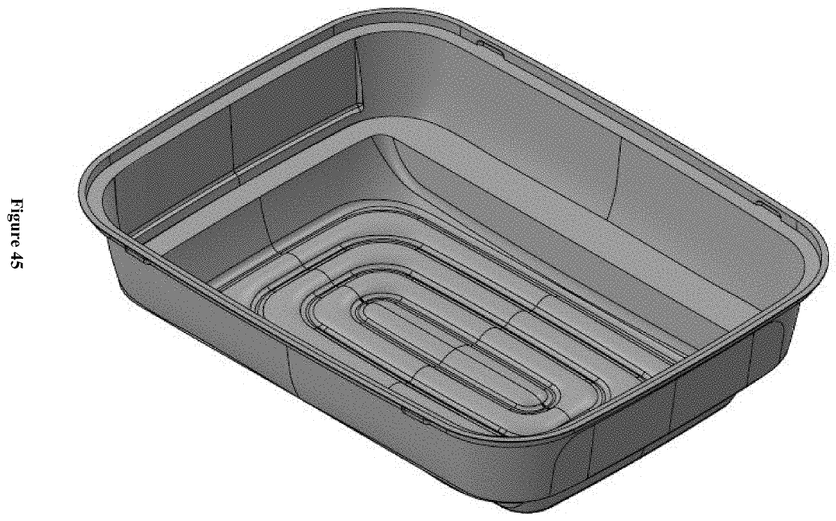

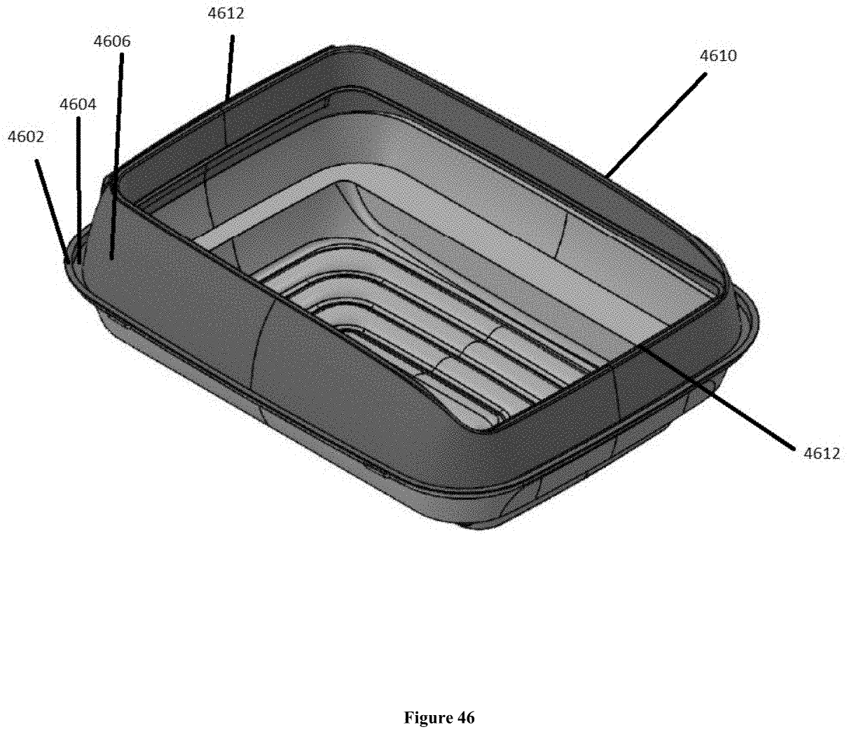

FIGS. 44-46 illustrate additional example embodiments of a container, according to aspects of the disclosure (although characteristics discussed with regard to this aspect may apply to other aspects, and vice versa, as any characteristics discussed herein with one embodiment may be applied in others). As illustrated here, sidewalls may be essentially vertical, curved so as to extend upward, and may include horizontal character at least in part. As also illustrated here, the container may include multiple horizontal transition surfaces, in addition to a top horizontal surface. As shown by the example of FIG. 46, the lid may cover a top horizontal surface 4602, then extend downward into the interior of the container, before having a horizontal transition 4604 and extending back upwards (or generally upwards) to provide a (at least somewhat) vertical wall 4606 that defines an interior cavity in combination with the container. The vertical wall may be uniformly shaped or, as illustrated in FIG. 46, may have sloped features to provide a front lower top edge 4608 for entry, higher sidewall edges 4610 and a higher backwall edge 4612 to help contain sorbing material(s) that may be agitated or dispersed.

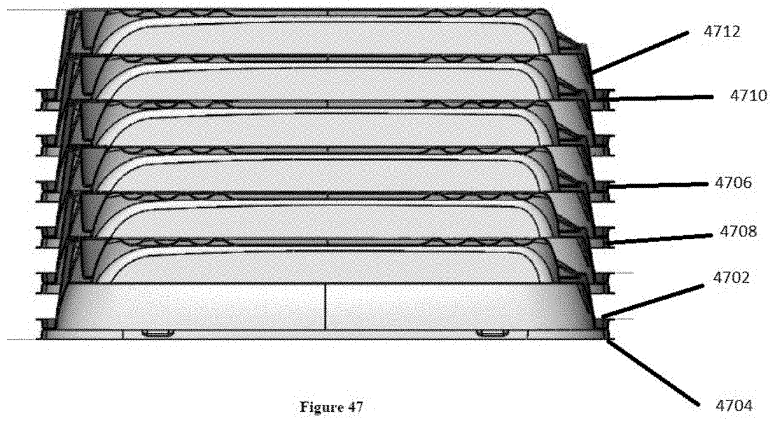

FIGS. 47-49 provide an example of this aspect where a container system of multiple containers allows for stacking of one container on the removable cover of another container, such that multiple containers with a nested lid and box may be stacked to provide for efficient storage and/or transport. Such Figures illustrate that a horizontal surface may be used to contact a top horizontal surface of the container, then have walls that at least partially vertically transition in one direction, before reversing (via a horizontal surface, but other orientations are possible, such as a somewhat horizontal surface) and then least partially vertically transitioning in the opposite direction to provide the main walls of the lid. As illustrated in these Figures, the container may nest inside a lid, or stacked containers may next inside stacked lids, or stacked lids may nest inside stacked containers. These nesting configurations are possible due to appropriately shaped and placed horizontal surfaces that may interface with each other, and have such interior and exterior shapes that each container and/or lid may nest have a stable resting place on a horizontal surface, i.e. has sufficient contact beyond the interior edge of the horizontal surface, while remaining inside the exterior edge of each horizontal surface, allowing successive stacking.

As an example, FIG. 47 illustrates horizontal surfaces 4702 (lid) and 4704 (container) that are in contact with each other in a typical use orientation. There are adjacent, essentially vertical surfaces 4706 (lid) and 4708 (container) before additional horizontal surfaces that are in contact with each other (at location 4710) when in one orientation, and are in contact with each other at the same location but using the opposing surface of the container horizontal surface when in an orientation where the lid is added on top of the container. Thus, horizontal surfaces are in contact with each other to facilitate storage in one orientation (as shown in FIG. 47), but then at least two horizontal surfaces and a vertical surface are in contact with each other when in another orientation (as shown in FIG. 46). This provides strength to the lid a container connection during use, while also facilitating appropriate nesting for storage, transport, and facilitating an easy transition between the two orientations. As also shown in Figure, larger vertical sidewalls of the container and lid (as shown at example contact area 4712) may have corresponding slopes, shapes, orientations, and positions to further facilitate nesting and provide a strong fit that is intuitive obtain when working with the lid and container.

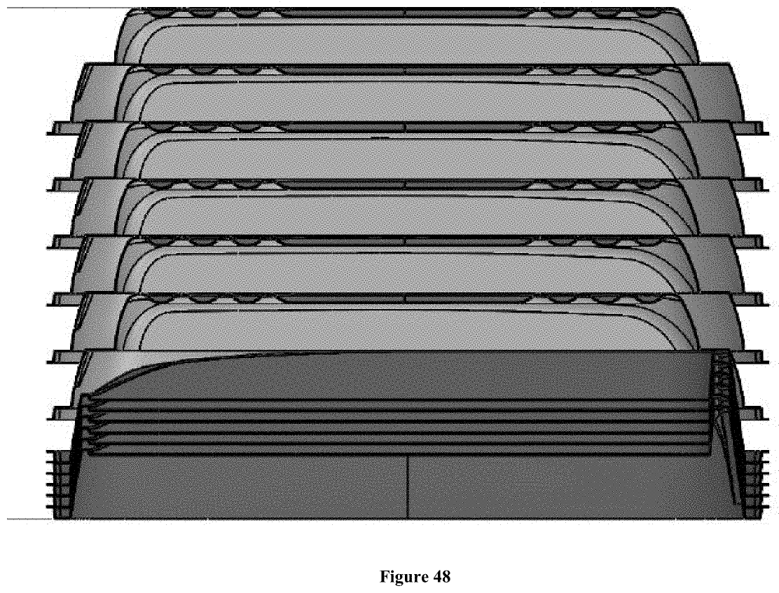

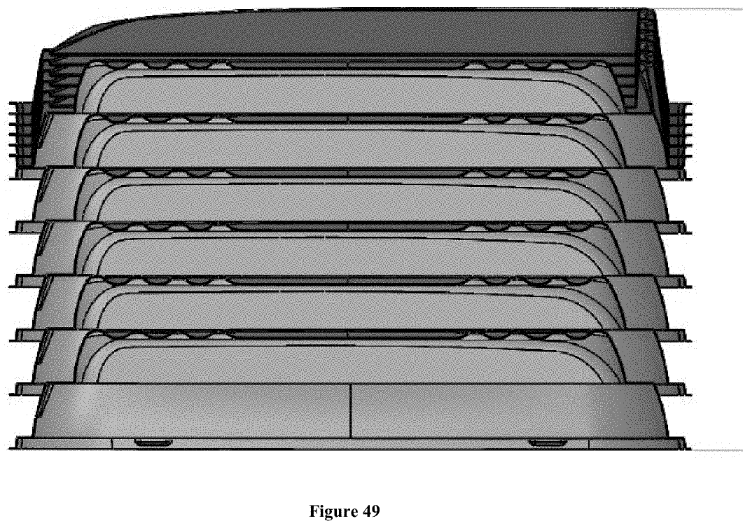

As illustrated in FIG. 48, the top of the lid may be shaped and sized such that it may nest within the bottom of the container, and the sidewalls of the lid are positioned (based on the slope and/or size of any horizontal transition surfaces) to be within any corresponding sidewalls of the container to facilitate nesting. As discussed herein, and as illustrated in the example FIG. 48, each of the container and lid may have sidewalls/surfaces with slopes and/or exterior and interior sizes such that each of the container and lid may nest within another part of the same type. As shown in FIGS. 48 and 49, the lid and containers may also have sidewalls/surfaces with slopes and/or exterior and interior sizes such that each of the container and lid may nest within or on top of the other part.

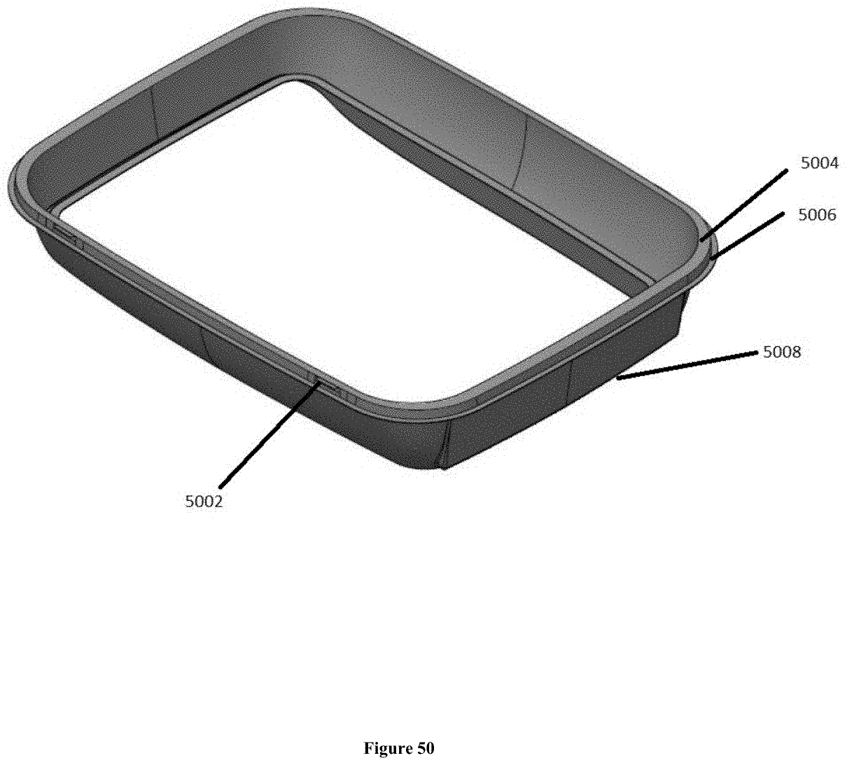

FIG. 50 shows another example embodiment of a container, according to aspects of the disclosure (although characteristics discussed with regard to this aspect may apply to other aspects, and vice versa, as any characteristics discussed herein with one embodiment may be applied in others). This Figure illustrates a type of connection feature 5002, where a tab and detent structure is configured to interface with a correspondingly shaped feature of the container, locking the lid into a desired position when placed on top of the container for use. This Figure also illustrates example sidewall and surface orientations and heights, including features where a horizontal surface 5004 further from the top edge of the lid 5006 (as the lid is placed on the container) is present with another, final horizontal surface 5008 of the lid that meets the outermost horizontal surface of the container, and that is closer to the top edge in terms of the vertical distance as compared to the other horizontal surface 5004.

Various embodiments of a container have been described herein, which include various components and features. In other embodiments, containers may be provided with any combination of such components and features. It is also understood that in other embodiments, the various devices, components, and features of the containers described herein may be constructed with similar structural and functional elements having different configurations, including different ornamental appearances.

Several alternative embodiments and examples have been described and illustrated herein.

A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. One skilled in the relevant art will recognize that numerous variations and modifications may be made to the examples described above without departing from the scope of the present disclosure. It is understood that the disclosure may be embodied in other specific forms without departing from the spirit or central characteristics thereof. The present examples and embodiments, therefore, are to be considered in all respects as illustrative and not restrictive, and the scope of the disclosure is not to be limited to the details given herein. Terms “top,” “bottom,” “left,” “right,” and the like, as used herein, are intended for illustrative purposes only and do not limit the embodiments in any way. Accordingly, while the specific embodiments have been illustrated and described, numerous modifications come to mind without significantly departing from the spirit of the disclosure.

What is claimed is:

1. A container comprising:
a box component comprising a bottom wall, a first pair of opposed sidewalls extending up from the bottom wall and a second pair of opposed sidewalls extending up from the bottom wall, each sidewall comprising a first surface and an opposed second surface, each sidewall further comprising one or more transition surfaces joining two primary surfaces of the sidewall and a top horizontal surface extending outward from the top of the first surface of the sidewall;
a lid component, comprising a first pair of opposed lid sidewalls and a second pair of opposed lid sidewalls, each lid sidewall comprising a first surface and an opposed second surface, each lid sidewall further comprising a lid horizontal surface extending outward from a first edge of the first surface of the sidewall; and
wherein each lid sidewall comprises a first lid horizontal surface extending outward from the sidewall a first vertical distance from a second edge of the lid, a vertical sidewall surface joining the first lid horizontal surface and a second lid horizontal surface extending outward from the vertical sidewall, wherein the second lid horizontal surface is a second vertical distance from the second edge of the lid, and wherein the second vertical distance is less than the first vertical distance.

2. The container of claim 1, wherein the box and lid are configured such that one of the box and lid will nest inside the other of the box and lid in a first orientation, where the lid horizontal surface is oriented such that the lid sidewalls extend downward from the first edge of the lid, and wherein the lid is configured to be secured to the top of the box in a second orientation, where the horizontal surface is oriented such that the lid sidewalls extend upward from the first edge of the lid

3. The container of claim 1, wherein the box sidewalls comprise two or more transition surfaces joining two primary surfaces of the sidewall.

4. The container of claim 3, wherein the transition surfaces are horizontal surfaces that are within 30 degrees of a parallel orientation with the bottom wall and the primary surfaces are vertical surfaces that are within 30 degrees of a perpendicular orientation with the bottom wall, and the one or more transition surfaces provide a ledge surface.

5. The container of claim 4, further comprising a cover, wherein the cover, the bottom wall, and the box sidewalls define an interior cavity, and wherein the cover is connected with the ledge surface.

6. The container of claim 3, wherein the bottom wall has a width and depth that is larger than an interior edge of the ledge surface, and smaller than an exterior edge of the ledge surface.

7. The container of claim 1, further comprising a cover, wherein the cover, the bottom wall, and the box sidewalls define an interior cavity.

8. The container of claim 7, wherein the cavity contains one or more sorbing materials.

9. The container of claim 1, wherein at least a portion of one lid sidewall has a height that is substantially 40% or less of the height of any other lid sidewall.

10. A container comprising:
a box component comprising a bottom wall, a first pair of opposed sidewalls extending up from the bottom wall and a second pair of opposed sidewalls extending up from the bottom wall, each sidewall comprising a first surface and an opposed second surface, each sidewall further comprising a horizontal surface extending outward from the top of the first surface of the sidewall;
a lid component, comprising a first pair of opposed sidewalls and a second pair of opposed sidewalls, each sidewall comprising a first surface and an opposed second surface, each sidewall further comprising a horizontal surface extending outward from the top of the first surface of the sidewall; and
wherein the lid is configured to nest inside the box in a first orientation, where the horizontal surfaces of the lid and box are in contact with each other.

11. The container of claim 10, wherein the horizontal surfaces of the lid and box comprise one or more connection features that secure the lid and box together in the first orientation.

12. The container of claim 10, wherein the lid is configured to become secured to the top of the box in a second orientation, where the horizontal surfaces of the lid and box and in contact with each other, and wherein an opposite side of the lid horizontal surface is placed in contact with the horizontal surface of the box.

13. The container of claim 12, wherein the horizontal surfaces of the lid and box comprise one or more connection features that secure the lid and box together in the first orientation, the second orientation, and/or both.

14. The container of claim 10, wherein one or more box sidewalls further comprise one or more transition surfaces joining two primary surfaces of the sidewall.

15. The container of claim 14, wherein the bottom wall has a width and depth that is larger than an interior edge of the ledge surface, and smaller than an exterior edge of the ledge surface.

16. The container of claim 14, further comprising a cover, wherein the cover, the bottom wall, and the box sidewalls define an interior cavity.

17. The container of claim 14, further comprising a cover, wherein the cover, the bottom wall, and the box sidewalls define an interior cavity, and wherein the cover is connected with the ledge surface.

18. The container of claim 17, wherein the cavity contains one or more sorbing materials.

19. The container of claim 14, wherein the transition surfaces are horizontal surfaces that are within 30 degrees of a parallel orientation with the bottom wall and the primary surfaces are vertical surfaces that are within 30 degrees of a perpendicular orientation with the bottom wall, and the one or more transition surfaces provide a ledge surface.

20. A container comprising:
a box component comprising a bottom wall, a first pair of opposed and a second pair of opposed sidewalls extending up from the exterior edges of the bottom wall, a cover component, comprising a cavity surface and at least one handle portions extending upward from the cavity surface;
wherein each sidewall comprises a lower sidewall section extending generally upwards from the bottom wall, a transition surface extending away from a top of the lower sidewall section, where the top of the lower sidewall section provides an interior edge of the transition surface, and an upper sidewall section extending generally upwards from an outer edge the transition surface;
wherein the bottom wall, lower sidewall sections, and cavity surface define an interior cavity when the cover is positioned on top of the transition surfaces of the sidewalls;
wherein the interior cavity is at least partially filled with a sorbing material;
wherein each sidewall comprises a top horizontal surface extending away from an external surface of the upper sidewall section;
wherein the cover comprises one or more handles extending generally upwards from the cover surface and then wrapping around to a location underneath and interior to an outer edge of the top horizontal surface;
wherein an exterior shape defined by the outer edges of the transition surfaces is larger than a corresponding shaped exterior shape area defined by the exterior edges of the bottom wall; and
wherein an interior shape defined by the interior edges of the transition surfaces is smaller than the corresponding shaped exterior shape area defined by the exterior edges of the bottom wall.
